(19) United States
(12) Patent Application Publication
(10) Pub. No.: US 2005/0215713 A1
(43) Pub. Date: Sep. 29, 2005

(54) Method of producing a crosslinked coating in the manufacture of integrated circuits

(76) Inventors: Edward T. Hessell, Fairfield, CT (US); Richard Abramshe, Highland, NY (US); Ramachandran P. Subrayan, Stamford, CT (US); Ramanathan Ravichandran, Suffern, NY (US)

Correspondence Address: MORGAN & FINNEGAN, L.L.P., 3 World Financial Center, New York, NY, 10281-2101, US

(21) Appl. No.: 11/093,105

(22) Filed: Mar. 28, 2005

Related U.S. Application Data
(60) Provisional application No. 60/556,720, filed on Mar. 26, 2004.

(51) Int. Cl. C08K 5/07

(52) U.S. Cl. 525/162

(57) ABSTRACT

The present invention is directed to a method of providing a thermally curable coating composition for to provide positive photoresists layers, underlayers for multiple layer resists, antireflective coatings, bottom layer antireflective coatins, dielectric layers, photoresist layers, hard mask etch stops, in the manufacture of integrated circuits. More particularly, the present invention is directed to a method of using a thermally activable latent acid or a thermal acid generator, a N-benzylpyridinium or N-benzylanilinium salt of a strong acid, as a catalyst in a polymerizable composition suitable for preparing such coatings and layers. The present invention is also directed to novel compositions comprising benzylpyridinium and benzylanilinium salts of a strong acid, such as sulfonic acid or disulfonic acid as thermal acid generators.

### FIELD OF THE INVENTION

The present invention is directed to a method of providing a thermally curable coating composition that is permanent or removable for the manufacture of integrated circuits. More particularly, the present invention provides a method of preparing a thermally curable film forming composition comprising a thermally activable latent acid or a thermal acid generator, a N-benzylpyridinium or N-benzylanilinium salt of a strong acid, as a catalyst. The present invention is also directed to novel compositions comprising benzylpyridinium and benzylanilinium strong acid salts as thermal acid generators.

### BACKGROUND OF THE INVENTION

Integrated circuit production relies on the use of microphotolithographic processes to define the active elements and interconnecting structures for microelectronic devices. Until recently, the wavelengths of light used in the bulk of microphotolithographic applications are the g-line (436 nm) and the I-line (365 nm). As the dimensions of the structures of an integrated circuit become smaller and smaller to achieve increased resolution, the wavelength used for microphotolithography in semiconductor manufacturing has been reduced into the deep UV region with a wavelength in the range of 256 nm to 193 nm. A problem is that the resist compositions used at the higher wavelengths of 436 nm and 365 nm were too absorbent and insensitive at the wavelengths in the deep UV region. Thus, in order to utilize wavelengths in the deep UV region, new resist materials with low optical absorption and enhanced sensitivities are needed.

Chemically amplified resist materials through the use of acid-labile polymers have recently been developed in order to meet the requirements of microphotolithography processes employing wavelengths in the deep UV region. Although, the acid-labile polymers in the chemically amplified resist materials have shown great promise for increasing the resolution, there are many shortcomings.

First, there are the standing wave effects, which occur when monochromatic deep UV light is reflected off the surface of a substrate during exposure. The standing wave effects cause line width variations with a resultant reduction in resolution. For example, standing waves in a positive resist tends to result in the formation of a foot at the resist/substrate interface resulting in a reduction in the resolution.

Second, substrate poisoning by chemically amplified resist can change structural profiles and resolution. This generally happens when the substrate has a nitride layer. It is believed that the N—H bond in the nitride deactivates the acid at the nitride/resist interface. For a positive resist, this results in insolubility, leading to either resist scumming, or a foot at the resist/substrate interface, both of which causes a reduction in the resolution.

Third, the lithographic aspect ratios for printing features below 0.18 μm require a thin chemically amplified resist layer, e.g., about 0.5 μm. This in turn requires the resist to have excellent plasma etch resistance such that the resist image features can be transferred down into the underlying substrate. However, in order to decrease absorbance of the chemically amplified resist, aromatic groups, such as those in NOVOLAK® resins, had to be removed. This in turn decreased the etch resistance.

Various solutions have been proposed for these problems. One solution proposed is the use of special multilayer coatings techniques, generally referred to as bilayer resists, whereby a non-photosensitive underlayer or undercoat film is first placed on the substrate followed by a thin photosensitive chemical amplified film. The use of an undercoat provides several advantages. First, most of the deep UV light is absorbed, thereby attenuating the standing wave effects. Second, the undercoat can also be thermally cured to provide the necessary etch resistance properties. Third, the underlayer prevents deactivation of the acid catalyst at the resist/substrate interface to prevent the formation of a foot. Fourth, the underlayer can contain some aromatic groups that also provide etch resistance. For a discussion of the underlayer for Bilayer/Multilayer Resist (see U.S. Pat. No. 6,323,287 or U.S. Pat. No. 6,165,682).

In a typical process to provide a bilayer resist, the undercoat layer of about 0.5 to 1 μm thick is applied on the substrate. A chemically amplified resist is then applied on the undercoat layer, then exposed to deep UV light and developed to form images in the chemically amplified resist topcoat. For thermally crosslinkable underlayers, the thermal crosslinking step can be conducted either before or after the application of the chemically amplified resist, depending on the choice of top photoactive coating layer. The bilayer resist system is then placed in an oxygen plasma etch environment to etch the undercoat in the areas where the chemically amplified resist has been removed in the development process step. The chemically amplified resist in a bilayer system typically contains silicon and is able to withstand oxygen plasma etching. After the bottom layer is etched, the resist system can then be used for subsequent processing such as a non-oxygen plasma etch to remove the underlying substrate.

The crosslinking or curing to form some of the undercoat layers are by heating. However, the problem with these undercoat layers is that they require high curing temperatures and long curing times before the top layer can be applied. In order to be commercially useful, an undercoat layer should be curable at a temperature below 250° C. and in less than 180 seconds. After curing, the undercoat should have a high glass transition temperature to withstand the subsequent high temperature processing.

To make such underlayers commercially useful, one way to simultaneously lower the cure temperature and increase the rate of cure (i.e., shorten the cure time) is to introduce an acid catalyst into the formulation. Unfortunately, the introduction of an acid catalyst per se results in a formulation with poor shelf stability at room temperature. This is because with the acid catalysts used presently, significant crosslinking of the undercoat resin will occur even at room temperature over an extended period of time. Thus, compositions containing an acid catalyst have not been found acceptable for use to form underlayers.

Compositions for use in the manufacture of an integrated circuit must be stable in storage at room temperature for periods of up to 12 months prior to use. Thus, the use of a composition containing known acid catalysts per se is not an option. There exists a need for a latent catalyst that can be thermally activated for such underlayer coatings systems. The latent catalyst would be inactive during storage and only becomes active during the thermal curing process. Such thermal latent catalysts are referred to as thermal acid generators.

A second major area requiring the development of new materials suitable for integrated circuit manufacture is in dielectric materials.

In an effort to increase the performance and speed of semiconductor devices, semiconductor device manufacturers have sought to reduce the line width and spacing of interconnects while minimizing transmission losses and reducing the capacitative coupling of the interconnects. One way to diminish power consumption and reduce capacitance is by decreasing the dielectric constant (also referred to as “k”) of the insulating or dielectric material, that separates the interconnects. Insulating materials having low dielectric constants are especially desirable, because they typically allow faster signal propagation, reduce the capacitance and cross talk between conductor lines, and lower the voltage for driving the integrated circuits.

Air is defined to have a dielectric constant of 1.0. Thus, a major goal is to reduce the dielectric constant of the insulating materials down to a theoretical limit of 1.0. Several methods have been developed in the art for this purpose. These methods include adding certain elements such as fluorine to the composition to reduce the dielectric constant of the bulk material. Other methods include use of alternative dielectric material matrices.

As the interconnect linewidths decrease, concomitant decreases in the dielectric constant of the insulating materials used are required to achieve the improved performance and speed desired of semiconductor devices. For example, for devices having interconnect linewidths of 0.13 or 0.10 micron and below, an insulating material having a dielectric constant k<3 will be required.

Currently silicon dioxide (SiO₂) and modified versions of SiO₂, such as fluorinated silicon dioxide or fluorinated silicon glass (hereinafter FSG) are used. These oxides, which have a dielectric constant ranging from about 3.5-4.0, are commonly used as the dielectric in semiconductor devices. While SiO₂ and FSG have the mechanical and thermal stability needed to withstand the thermal cycling and processing steps of semiconductor device manufacturing, materials having a lower dielectric constant are desired in the industry.

Methods used to deposit dielectric materials may be divided into two categories: spin-on deposition (hereinafter SOD) and chemical vapor deposition (hereinafter CVD). Several efforts to develop lower dielectric constant materials include altering the chemical composition (organic, inorganic, blend of organic/inorganic) or changing the dielectric matrix (porous, non-porous). Compositions useful as spin on dielectric materials as well as methods for their application and curing are well known. Hydrogensilsesquioxane (HSQ) resins are reported in U.S. Pat. No. 4,756,977, U.S. Pat. No. 5,370,903, U.S. Pat. No. 5,486,564, and WO 00/40637; methylsilsesquioxane resins are reported in U.S. Pat. No. 6,143,855, portions of which are incorporated herein as reference; other polyorganosilicon resins are reported in U.S. Pat. No. 6,225,238.

Despite the efficacy of these organo-silicon coatings, the ceramification of these materials at temperatures less than 400° C. is very slow. Thus, they are impractical for commercial processes for the manufacture of integrated circuit. On the other hand, if temperatures greater than 400° C. are used, various temperature sensitive devices can be destroyed. Therefore, there is a need for a method of rapidly preparing such ceramic coatings at low temperatures.

Various amines have been incorporated into alkyl orthosilicate solutions for use as catalysts in hydrolytic reactions in other manufacturing processes. For instance, Hitachi's Japanese Patent J62265129 describes the incorporation of an amine in a silicon alkoxide solution to form a silica sol for use in producing silica glass. Similarly, Kanegafuchi, Japanese Patent J57118592 discloses the incorporation of an amine into an alcoholic solution of a trialkoxysilane to form a stable composition.

Haluska et al., U.S. Pat. No. 5,262,201 and Baney et al., U.S. Pat. No. 5,116,637 descibe the use of basic catalysts to lower the temperature necessary for the conversion of various materials, including hydrogen silsesquioxane, to ceramic coatings. Camilletti et al., U.S. Pat. No. 5,547,703 discloses a method for forming a low dielectric constant Si—O containing coating on a substrate wherein a hydrogen silsesquioxane resin is thermally cycled successively under wet ammonia, dry ammonia and oxygen. The resultant coatings have a dielectric constant as low as 2.42 at 1 MHz.

It would be desirable to manufacture films with a low dielectric constant from siloxane based resins using standard processing techniques at lower temperatures and in a shorter period of time. In this manner curing processes that require an ammonia or ammonia derivative type of atmosphere (Ballance et al. U.S. Pat. No. 5,145,723, 1992,), an ozone atmosphere (Haluska et al. U.S. Pat. No. 5,336,532), or other non-standard semiconductor process, are avoided.

U.S. Pat. No. 5,326,827 discloses a curable acrylic polymer compositions having a plurality of alicyclic epoxide functions and a latent heat cationic polymerization initiator, an onium salt of nitrogen, sulfur, phosphorus or iodine with SbF₆⁻, BF₄⁻, PF₆⁻ or CF₃SO₃⁻ as anions.

U.S. Pat. No. 5,132,377 discloses a resinous composition comprising a film-forming resin capable of curing upon heating in the presence of a curing catalyst, of the type N-α-methyl benzyl-N,N-dialkly anilinium, or -1-(α,α,-dimethylbenzyl)pyridinium super acid salts. The resinous compositions include a silicon resin having a plurality of alkoxysilyl groups.

U.S. Pat. No. 5,066,722 discloses a heat-curable resinous composition comprising, a hydroxy group-containing, film-forming resin, an amount of a melamine resin, and a latent acid, a benzylpyridinium sulfonate or a benzyl ammonium sulfonate. U.S. Pat. No. 5,066,722 also mentions the potential uses of these catalysts in systems capable of curing by a self-condensation reaction of an alkoxysilyl group-containing resin, or curing through a co-condensation reaction of an alkoxysilyl group-containing resin and a hydroxy group-containing resin.

### BRIEF DESCRIPTION OF THE DRAWING

FIG. 1 is a graph generated using differential scanning calorimetry and thermal gravimetric analyis on N-(4-methoxybenzyl)-N,N-dimethyaniliniam tiflateof the present invention.

### SUMMARY OF THE INVENTION

The present invention is directed to a method of preparing a thermally curable film coating for the manufacture of an integrated circuit by blending a thermal acid generator useful as a latent, heat activatable catalyst selected from the group consisting of a benzylpyridinium and benzylanilinium salt of a strong acid with a film forming polymerizable composition selected from the group consisting of:
a. a cation-polymerizable composition selected from the group consisting of:
   i. a substituted or unsubstituted monofunctional epoxy compound selected from the group consisting of: 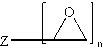
   wherein Z is H, a C₁-C₂₀ alkyl, a C₁-C₂₀ alkene, a CS—C₆ cycloalkyl, or a C₅-C₁₀ aryl and n is 1-3; 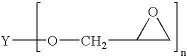
   where Y is a C₁-C₂₀ alkyl, benzyl, vinyl, allyl, a C₅-C₆ cycloalkyl, or a C₅-C₁₀ aryl and n is 1-3;
      a glycidyl ester, diglycidylester, or triglycidyl ester: 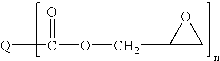
      wherein Q is a C₁-C₁₀ alkyl, vinyl, a C₅-C₆ cycloalkyl, C₅-C₁₀ aryl and n is 1-3; an alicyclic epoxide: 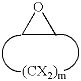
      wherein X is H, C₁-C₅ alkyl, C₅-C₁₀ aryl, 1,2-epoxyethyl, acryloyl, alkyloxycarbonyl or alkyloxy wherein alkyl is C₁-C₂₀ alkyl, aryloxycarbonyl or aryloxy wherein the aryl group has C₅-C₁₀ carbons, and m is an integer from 3-5;
   ii. an epoxy functional group containing polymer selected from the group consisting of polyolefins, polyesters, polyacrylates, polyacrylamides and polymethacrylates, optionally comprising epoxides, diepoxides, polyepoxides of (i), or mixtures thereof
   iii. and each of the above optionally comprising a polyol;
b. a crosslinkable composition comprising a hydroxyl-group-containing resin selected from the group consisting of polyalkylene glycols, polyacrylates, polyolefins, and polyesters and a amino resin selected from the group consisting of urea-formaldehyde resins, melamine-formaldehyde resins, benzoquanamine-formaldehyde resins, glycoluril-formaldehyde resins and a mixture thereof;
c. a self-condensing resin selected from the group consisting of hydrogensilsesquioxane; methylsilsesquioxane; polyorganosilicon; and organohydridosiloxane resins having one of the four following formulae:
   (HSiO_{1.5})ₙ(RSiO_{1.5})ₘ Formula 1
   (H_{0.4-1.0} SiO_{1.5-1.8})ₙ(R_{0.4-1.0}SiO_{1.5-1.8})ₘ Formula 2
   (H_{0-1.0}SiO_{1.5-2.0})ₙ(RSiO_{1.5})ₘ Formula 3
wherein the sum of n and m is from 8 to 5000 and m is selected such that the organic moiety is present at at least 40 Mole percent (Mol %);
   (HSiO_{1.5})ₓ(RSiO_{1.5})_{y}(SiO₂)_{z} Formula 4
wherein x+y+z is from 8 to 5000 and y is selected such that the organic moiety is at least 40 mole percent (Mol %); and R is substituted and unsubstituted linear and branched alkyl, cycloalkyl, aryl, wherein alkyl is C₁-C₁₂ and aryl is C₅-C₁₀ and mixtures thereof; and
d. a co-condensing resin comprising an alkoxysilyl resin defined in c. above, wherein alkoxy is C₁-C₄ and a hydroxyl-group-containing resin selected from the group consisting of polyalkylene glycols, polyacrylates, polyolefins, and polyesters;
   dissolving the blended composition in a solvent selected from the group consisting of methanol, ethyl lactate, 2-heptanone, propylene glycol methyl ether acetate, and propylene glycol monomethyl ether;
   coating a substrate with the solution by spin coating, dip coating or spray coating; and
   heating the coated substrate to form a crosslinked, cured film coating.

The crosslinkable compositions useful in the method of the present invention are suitable in many aspects of the manufacture of integrated circuits. The crosslinkable coatings compositions of the present invention can be utilized as undercoats or underlayers for multilayer photoresist systems, antireflective coatings for traditional photoresists (ARCs), bottom layer antireflective coatings (BARCs), spin-on low k dielectric layers, positive acting photoresists and in spin on alkoxysilane or silanol functional hard mask etch stops.

The present invention is also directed to benzylanilinium acid salts of Formula I or benzylpyridinium acid salts of Formula II as depicted below for use as thermal acid generators in a method for the manufacture of integrated circuits. 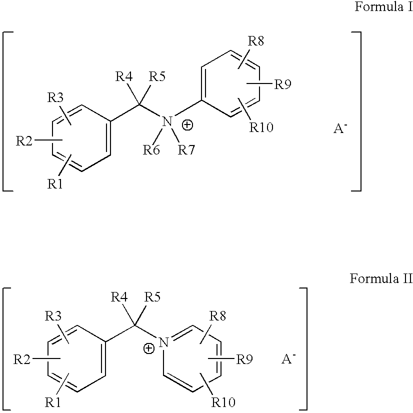
wherein R1, R2, R3, R8, R9, and R10 are independently hydrogen, halogen, alkyl, alkoxy, nitro, amino, alkylamino, cyano, alkoxycarbonyl, or carbamoyl; R4 and R5 are independently hydrogen, alkyl or halogen; R6 and R7 are independently hydrogen or alkyl, wherein the alkyl is C₁-C₃ and alkoxy is C₁-C₁₂;
and wherein A is selected from the group consisting of:
i. an aromatic sulfonate: 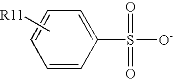
wherein R11 is alkyl, perfluoroalkyl, cyano, dialkylamino, alkoxycarbonyl or carbamoyl, wherein the alkyl group is C₁-C₁₂ alkyl;
ii. an alkylated naphthalene sulfonate: 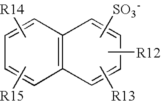
wherein R12, R13, R14 and R15 are independently hydrogen, C₁-C₁₂ alkyl or perfluoroalkyl, wherein the alkyl group is C₁-C₈ alkyl;
iii. an alkylated naphthalene disulfonate: 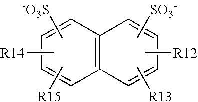
wherein R12 through R15 are as defined above;
iv. a fluorosubstituted C₁-C₁₂ alkyl sulfonate;
v. a sulfonamide: 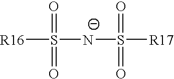
wherein R16 and R17 are independently aryl, alkyl, fluorosubstituted aryl, or fluorosubstituted alkyl, wherein the alkyl group is C₁-C₁₂ alkyl;
vi. a methide: 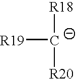
wherein R18, R19, and R20 are independently H or perfluroalkylsulfonyl, wherein alkyl is C₁-C₁₂. Preferably, the methide is trifluoromethylsulfonyl or nonafluorobutylsulfonyl,

### DETAILED DESCRIPTION OF THE INVENTION

The thermally curable compositions useful in the method of the present invention have excellent shelf lives at room temperature but undergo rapid cure at reasonable temperatures at a rapid rate and do not produce any volatile amines or other reactive volatile components during cure. They are particularly suitable for the manufacture of integrated circuits to provide multilayer photoresists, wherein thermal stress to the wafer must be minimized with short process times, leading to a high through put of the final product. The absence of any reactive volatile amine or hydroxyl-containing by-products from the thermally curable compositions during processing avoids undesirable contamination of fragile circuit components on the wafer, unwanted deposits on internal surfaces of expensive equipment, or contamination by base sensitive components of the photolithographic process via atmospheric migration to other compartments of the fabrication process.

To produce crosslinkable coatings for antireflective coatings (ARCs) or bottom layer antireflective coatings (BARCS), a variety of hydroxyl-containing resins known in the art are suitable. These include hydroxyl-containing polyacrylates, polyolefins, and polyesters. One example of a resin useful in the invention is exemplified in U.S. Pat. No. 6,114,085 and has the structure, 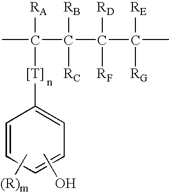
wherein R is hydrogen, halogen, nitro, C₁-C₄ alkyl, C₁-C₄ alkoxy, and m=1-4, R_{A} to R_{G} are independently hydrogen, halogen, C₁-C₄ alkyl, alicyclic group, C₁-C₄ alkoxy, CO₂ (alkyl)OH, CO₂ (alkyl)COCH₂ COCH₃, or RF and RG are combined to form a saturated ring or an anhydride; T is CO₂, O or SO₂ and n=0 or 1; and the weight average MW of the polymer is in the range of 1500 to about 50,000, preferably 4,000 to about 30,000, and more preferably 5,000 to about 20,000. Preferably the polymers are poly(hydroxystyrene), poly(hydroxystyrene-co-methyl acrylate), poly(hydroxystyrene-co-methyl methacrylate), or or mixtures thereof.

A second type of crosslinkable resin useful in the present invention are aromatic hydroxyl-containing polyester resins described in U.S. application 2003/0180559. The resin contains ester repeat units (polyester), such as provided by polymerization of a carboxy-containing compound (such as a carboxylic acid, ester, anhydride, etc.) and a hydroxy-containing compound, preferably a compound having multiple hydroxy groups such as a glycol, e.g. ethylene glycol or propylene glycol, or glycerol, or other diols, triols, tetraols and the like.

Preferably, the ester moiety is present as a component of, or within, the polymer backbone rather than as a pendant or side chain unit. Also preferred is a resin where the ester repeat unit is aromatic, such as optionally substituted aryl groups, e.g., optionally substituted phenyl, naphthyl or anthracenyl, either along the polymer backbone or as a side chain, but preferably along the polymer backbone.

The polyester resin component is obtained from polymerization of one or more monomers, oligomers or other polymerized subunits or materials that comprise hydroxy groups, e.g. 2, 3, or 4 hydroxy groups per monomer. Preferably, such hydroxy-containing polymerizable materials are reacted to form a polyester resin as discussed above, particularly by reaction of the hydroxy-containing compound with a carboxy-containing compound (such as a carboxylic acid, ester, anhydride, etc.). Examples of hydroxy-containing polymerizable materials include diol, triols and tetraols such as a glycol, e.g. ethylene glycol or propylene glycol, or glycerol. Suitable diols for the polester resin of the invention include e.g. ethylene glycol; 1,3-propanediol; 1,2-propanediol; 2,2-dimethyl-1,3-propanediol; 2,2-diethyl-1,3-propanediol; 2-ethyl-3-methyl-1,3-propanediol; 2-methyl-2-propyl-1,3-propanediol; 2-butyl-2-ethyl-1,3-propanediol; 1,4-butanediol; 2-methyl-1,4-butanediol; 1,2-butanediol; 1,3-butanediol; 2,3-butanediol; 2,3-dimethyl-2,3-butanediol; 1,5-pentanediol; 1,2-pentanediol; 2,4-pentanediol; 2-methyl-2,4-pentanediol; 1,6-hexandiol; 2,5-hexanediol; 1,2-hexanediol; 1,5-hexanediol; 2-ethyl-1,3-hexanediol; 2,5-dimethyl-2,5-hexanediol; 1,7-heptanediol; 1,8-octanediol; 1,2-octanediol; 1,9-nonanediol; 1,10-decanediol; 1,2-decanediol; 1,12-dodecanediol; 1,2-dodedanediol; 1,2-tetradecanediol; 1,2-hexadecanediol; 1,16-hexadecanediol; 1,2-cyclobutanedimethanol; 1,4-cyclohexanedimethanol; 1,2-cyclohexanedimethanol; 5-norbonene-2,2-dimethanol; 3-cyclohexene-1,1-dimethanol; dicyclohexyl-4,4′-diol; 1,2-cyclopentanediol; 1,3-cyclopentanediol; 1,2-cyclooctanediol; 1,4-cyclooctanediol; 1,5-cylcooctanediol; 1,2-cyclohexanediol; 1,3-cyclohexanediol; 1,4-cyclohexanediol; 1,2-cycloheptanediol; 2,2,4,4-tetramethyl-1,3-cyclobutanediol; 1,2-cyclododecanediol; decahydronaphthalene1,4-diol; decahydronaphthalene-1,5-diol; 3-chloro-1,2-propanediol; 1,4-dibromobutane-2,3-diol; 2,2,3,3-tetrafluorol,4-butanediol; diethylene glycol; triethylene glycol; tetraethylene glycol; pentaethylene glycol; dipropylene glycol; isosorbide; isomannide; 1,3-dioxane-5,5-dimethanol; 1,4-dioxane-2,3-diol; 1,4-dithiane-2,5-diol; 1,2-dithiane-4,5-diol; 2-hydroxyethyldisulfide; 3,6-dithia-1,8-octanediol; 3,3′-thiodipopanol; 2,2′-thiodiethanol; 1,3-hydroxyacetone; 1,5-dihydroxy-2,2,4,4-tetracholoro-3-pentanone; glyceraldehydes; benzopinacole; 1,1,4,4-tetrphenyl-1,4-butanediol; 3,4-bis(p-hydroxyphenol)-3,4-hexanediol; 1,2-benzenedimethanol; 1,4-benaenedimethanol; 2,3,5,6-tetramethyl-p-xylene-α,α′-diol; 2,4,5,6-tetrachlorobenzene-1,3-dimethanol; 2,3,5,6-tetrachlorobenzene-1,4-dimethanol; 2,2-diphenyl-1,3-propanediol; 3-(4-chlorophenoxy)-1,2-propanediol; 2,2′-(p-phenylenedioxy)-diethanol; 5-nitro-m-xylene-α,α′-diol; 1,8-bis(hydroxymethyl)naphthalene; 2,6-bis(hydroxymethyl)-p-cresol; 0,0′-bis(2-hydroxyethyl)benzene; 1,2-O-isopropylidenexylofuranose; 5,6-Isopropylideneascorbic acid; 2,3-O-isopropylidenethreitol; and the like. Specifically suitable triols for reaction to form an antireflective composition resin of the invention include e.g. glycerol; 1,1,1-tris(hydroxymethyl)ethane; 2-hydroxymethyl-1,3-propanediol; 2-ethyl-2-(hydroxymethyl)-1,3-propanediol; 2-hydroxymethy-2-propyl-1,3-propanediol; 2-hydroxymethy-1,4-butanediol; 2-hydroxyethyl-2-methyl-1,4-butanediol; 2-hydroxymethyl-2-propyl-1,4-butanediol; 2-ethyl-2-hydroxyethyl-1,4-butanediol; 1,2,3-butanetriol; 1,2,4-butanetriol; 3-(hydroxymethyl)-3-methyl-1,4-pentanediol; 1,2,5-pentanetriol; 1,3,5-pentanetriol; 1,2,3-trihydroxyhexane; 1,2,6-trihydroxyhexane; 2,5-dimethyl-1,2,6-hexanetriol; tris(hydroxymethyl)nitromethane; 2-methyl-2-nitro-1,3-propanediol; 2-bromo-2-nitro-1,3-propanediol; 1,2,4-cyclopentanetriol; 1,2,3-cylcopentanetriol; 1,3,5-cyclohexanetriol; 1,3,5-cyclohexanetrimethanol; 1,3,5-tris(2-hydroxyethyl)cyanuric acid; 1,2-O-Isopropylideneidofuranose; 1,2-O-isopropylideneglucofuranose; crotonic acid; and the like.

Generally preferred chromophores for inclusion in the polyester coating compositions of the invention include both single ring and multiple ring aromatic groups such as optionally substituted phenyl, optionally substituted naphthyl, optionally substituted anthracenyl, optionally substituted phenanthracenyl, optionally substituted quinolinyl, and the like. Particularly preferred chromophores may vary with the radiation employed for processing an overcoated resist layer. More specifically, for antireflective coatings, where the exposure of an overcoated resist is at 248 nm, optionally substituted anthracenyl and optionally substituted naphthyl groups are preferred. Whereas, for exposure of an overcoated resist at 193 nm, optionally substituted phenyl and optionally substituted naphthyl are particularly preferred chromophores. Preferably, such chromophore groups are linked (e.g. pendant groups) to a resin component of the antireflective composition, such as the polyester resin as discussed above. Particularly preferred chromophore groups are aryl dicarboxylates, particularly naphthyl dicarboxylate and phenyl dicarboxylate groups.

Additionally, antireflective compositions may contain a material that contains chromophore units that is separate from the polyester resin component. For instance, the coating composition may comprise a polymeric or non-polymeric compound that contain phenyl, anthracene, naphthyl, etc. units. It is often preferred, however, that the ester-resin contain chromophore moieties.

For producing coatings for underlayers for bilayer or trilayer photoresist systems useful resins comprise a block co-polymer of a hydroxyl-containing polymer. Any suitable film-forming organic polymers can be used as the film-forming material for the first coating (undercoat layer). The film forming polymers are phenolic resins selected from the group consisting of NOVOLAK® resins, such as formaldehyde cresol or formaldehyde phenol novolaks, polyimide resins, poly(meth)acrylate resins, styrene-allyl alcohol copolymer resins, aromatic polyesterpolyols and copolymers of isobornyl methacrylate and hydroxystyrene. Representative examples of resin systems useful for underlayer coatings can be found in U.S. Pat. No. 6,610,808 to Binod, et. al., and U.S. Pat. No. 6,323,287 to Foster, et. al.

The thermally curable polymer composition may comprise a hydroxyl-containing polymer: a cyclohexanol, a hydroxystyrene, hydroxyalkyl acrylate or methacrylate, hydroxycycloalkyl acrylate or methacrylate, arylalkyl alcohols, allyl alcohol and the like. Preferably, the hydroxyl containing polymers have a number average molecular weight of about 9000 to 38,000, more preferably 14,000 to 30,000 and even more preferably about 18,000 to 22,000.

In addition, the thermally curable polymer composition of the present invention may also further comprise monomer units of cycloaliphatic esters of acrylic or methacrylic acid. Suitable examples of monomer units of cycloaliphatic esters of acrylic or methacrylic acid are cyclohexyl acrylate or methacrylate, 4-tert-butylcyclohexyl acrylate or methacrylate and isobornyl acrylate or methacrylate, adamantyl acrylates and methacrylates, dicyclopentenyl acrylates and methacrylates, 2-(dicylcopenteneyloxy)ethyl acrylates and methacrylates and the like. The preferred monomer units of cycloaliphatic ester of acrylic or methacrylic acid are isobornyl acrylate or methacrylate.

The hydroxyl-containing polymer may further comprise aromatic monomer units, preferably styrene or biphenyl acrylate or methacrylate. Examples of suitable hydroxyalkyl acrylate or methacrylates monomer units are hydroxymethyl acrylate or methacrylate, 2-hydroxyethyl acrylate or methacrylate, 3-hydroxypropyl acrylate or methacrylate, 4-hydroxybutyl acrylate or methacrylate, 5-hydroxypentyl acrylate or methacrylate, and 6-hydroxyhexyl acrylate or methacrylate and the like. Preferably, the hydroxyalkyl acrylate or methacrylate monomer units contains primary hydroxyl groups, although secondary and tertiary hydroxyl groups or mixtures of primary and secondary or primary, secondary and tertiary hydroxyl groups may be used. Suitable examples of compounds containing secondary hydroxyl are 2-hydroxy-2-methylethyl acrylate or methacrylate, 3-hydroxy-3-methypropyl acrylate, 4-hydroxy-4-methylbutyl acrylate or methacrylate, 5-hydroxy-5-methyl propyl acrylate or methacrylate, and the like. The preferred hydroxyalkyl acrylate or methacrylate is 2-hydroxyethyl acrylate or methacrylate. Suitable examples of arylalkyl alcohol monomer units are benzyl alcohol, 4-methyl-benzyl alcohol, 4-ethyl-benzyl alcohol, cumyl alcohol, alpha-methyl benzyl alcohol, 2-phenyl-1-ethanol, 3-phenyl-1-propanol, and 1-naphthyl methanol.

Other preferred copolymers useful in the thermally curable polymer composition are a copolymer of styrene and allyl alcohol with a weight average molecular weight of about 2000 to 20,000, preferably 2000 to 10,000; and a copolymer of hydroxystyrene and a cycloaliphatic esters of acrylic or methacrylic acid with a number average molecular weights of about 9000 to 38,000, preferably about 14,000 to 30,000, more preferably about 18,000 to 22,000.

Crosslinkable resins useful in the formation of positive photoresists are disclosed in U.S. Pat. No. 5,650,261 to Winkle, portions of which are included within as reference.

Preferred film forming polymers are acrylic polymers, epoxy polymers, polyurethanes, polyesters and polyamides, and more preferably, in the electrodeposition embodiment of the invention, methacrylate copolymers containing either, or both, pendant hydroxyl and carboxyl groups. Preferred monomers useful for preparing the film forming polymer include acrylic and methacrylic acid, lower C₁-C₈ alkyl esters of methacrylic acid and hydroxy-substituted methacrylates such as for example 2-hydroxyethyl acrylate, and 2-hydroxyethyl methacrylate.

Other vinyl monomers containing pendant carrier groups may be polymerized with acrylic and methacrylic monomers to incorporate pendant carrier groups onto the polymer backbone for electrodeposition of the photoresist composition. These vinyl comonomers include for example styrene and substituted styrene, vinyl halides such as vinyl chloride, vinyl esters such as vinyl acetate, and vinyl ethers such as methyl vinyl ether, and the like used alone or in combination.

The polymer or polymers should have a weight average molecular weight in the range of from about 3,000 to about 200,000. Polymers having a weight average molecular weight less than about 100,000 are preferred, and when the photoresist composition is to be applied electrophoretically onto a conductive substrate surface, the weight average molecular weight of the polymer should preferably be in the range of from about 5,000 to about 100,000, and more preferably in the range of from about 10,000 to about 80,000 weight average molecular weight.

When the above described hydroxyl functional resins are combined with a suitable amino crosslinker and a thermal acid generator and then heated, the resin and crosslinker undergo an acid catalysed condensation to form a three dimensional crosslinked network. Suitable crosslinkers for use in the photoresist composition of the invention include aminoplasts and phenoplasts. Suitable aminoplast resins include for example urea-formaldehyde, melamine-formaldehyde, benzoguanamine-formaldehyde, glycoluril-formaldehyde resins and combinations thereof.

Other crosslinkers include those disclosed in Shipley, EP 542008 incorporated herein by reference. For example, suitable antireflective composition crosslinkers include amine-based crosslinkers such as melamine materials, including melamine resins such as manufactured by Cytec and sold under the tradename of CYMEL® 300, 301, 303, 350, 370, 380, 1116 and 1130. Glycolurils are particularly preferred including glycolurils available from Cytec as POWDERLINK® 1174. Benzoquanamines and urea-based materials also will be suitable including resins such as the benzoquanamine resins available from Cytec under the name CYMEL® 1123 and 1125, and urea resins available from Cytec under the names of BEETLE® 60, 65, and 80. In addition to being commercially available, such amine-based resins may be prepared e.g. by the reaction of acrylamide or methacrylamide copolymers with formaldehyde in an alcohol-containing solution, or alternatively by the copolymerization of N-alkoxymethyl acrylamide or methacrylamide with other suitable monomers.

For producing coatings for spin-on inner layer dielectric materials and or etch stop masks, a variety of siloxane resins are useful. These are self-condensing at elevated temperatures or in the presence of a catalyst, i.e., they do not require an amino crosslinking agent. The following resin types have been disclosed as useful as low k spin-on dielectric materials. These include hydrogensilsesquioxane (HSQ) resins (See, U.S. Pat. No. 4,756,977; U.S. Pat. No. 5,370,903; U.S. Pat. No. 5,486,564, and PCT WO 00/40637); methylsilsesquioxane resins (See, U.S. Pat. No. 6,143,855); polyorganosilicon resins (See, U.S. Pat. No. 6,225,238). These references are incorporated herein by reference.

Illustrative resins useful as spin-on dielectric materials are disclosed in U.S. Pat. No. 6,143,855 and U.S. Pat. No. 6,361,820 to Hacker, et. al., and are solutions of organohydridosiloxane resins having one of the four general formulae:
(HSiO1.5)ₙ(RSiO_{1.5})ₘ Formula 1
(H_{0.4-1.0}SiO_{1.5-1.8})ₙ(R_{0.4-1.0}SiO_{1.5-1.8})ₘ Formula 2
(H_{0-1.0}SiO_{1.5-2.0})ₙ(RSiO_{1.5})ₘ Formula 3
wherein the sum of n and m is from about 8 to about 5000 and m is selected such that the organic moiety is present at about 40 Mole percent (Mol %) or greater;
(HSiO_{1.5})ₓ(RSiO_{1.5})_{y}(SiO₂)_{z} Formula 4
wherein x+y+z is from about 8 to about 5000 and y is selected such that the organic moiety is present at about 40 mole percent (Mol %) or greater; and R is substituted and unsubstituted linear and branched alkyl, cycloalkyl, aryl, and mixtures thereof, wherein the alkyl is C₁-C₁₂ and aryl is C₅-C₁₀. The specific Mol % of the carbon containing moiety is determined by varying the mole ratio of the starting materials, hydridotrihalosilane (H-Si) to organotrihalosilane (R-Si).

The organo silicon Polymers in accordance with the present invention have a caged structure with a polymer backbone encompassing alternate silicon and oxygen atoms. In particular, each backbone silicon atom is bonded to at least three backbone oxygen atoms. In contrast with previously known organosiloxane resins, polymers of the present invention have essentially no hydroxyl or alkoxy groups bonded to backbone silicon atoms. Rather, each silicon atom, in addition to the backbone oxygen atoms, is bonded only to hydrogen atoms and/or the ‘R’ groups defined in Formulae 1, 2, 3 and 4. By attaching only hydrogen and/or ‘R’ groups directly to backbone silicon atoms in the polymer, the shelf life of organohydridosiloxane resin solutions in accordance with the present invention is enhanced as compared to solutions of previously known organosiloxane resins.

The synthesis of the organohydridosiloxane compositions of this invention include a dual phase solvent system using a catalyst. In an embodiment of the present invention, the starting materials encompass trichlorosilane and one or more organotrichlorosilanes, for example either an alkyl or an aryl substituted trichlorosilane. In another embodiment, a solution of at least one organotrihalosilane and one hydridotrihalosilane are blended to form a mixture. A dual phase solvent, which includes both a non-polar solvent and a polar solvent and a catalyst are added to the trihalosilane mixture to provide a dual phase reaction mixture. The dual phase reaction mixture is allowed to react to produce an organohydridosiloxane. The organohydridosiloxane is recovered from the non-polar portion of the dual phase solvent system. In another embodiment, additional steps may include washing the recovered organohydridosiloxane to remove any low molecular weight species, and fractionating the organohydridosiloxane product to obtain products according to their molecular weights.

Another hydrogensilsesquioxane useful for preparing spin-on inner layer dielectric materials and or etch stop masks are prepared by methods described in U.S. Pat. No. 3,615,272 to Collins, et. al. The method of producing partially condensed hydrogensilsesquioxanes comprises the steps of:
a. adding a solution of trichloro-, trimethoxy-, or triacetoxysilanes in an hydrocarbon solvent to a two-phase reaction medium comprising concentrated sulfuric acid and an aromatic hydrocarbon while mixing the two-phase acid medium to effect condensation of the silanes;
b. washing the reaction mixture with water until substantially neutral;
c. recovering condensed hydrogensilsesquioxanes ticby evaporation of the hydrocarbon solvent and aromatic hydrocarbon.
   Trichlorosilane is the preferred reactant because of its ready availability. Other suitable silanes include triacetoxysilane and trimethoxysilane.

The above method results in very high yields of partially condensed hydrogensilsesquioxane. The method may be employed in a batch process or as a continuous process. A continuous column reaction-separation technique with recovery and recycle of the acid is preferred.

When the partially condensed hydrogensilsesquioxanes described above are combined with a thermal acid generator according to the present invention, the compositions are excellent precursors for the formation of fully condensed silsesquioxane-based inner layer dielectric materials. The thermal acid generator can promote a higher degree of cage formation at lower temperatures and are more rapidly cured than in the absence of a catalyst. This reduces the overall thermal stress on the wafer and its associated components.

Examples of resins especially suited for etch stop masks are, U.S. Pat. App. 2003/0096090 to Boisvert, et. Al., silicone resins comprising 5 to 50 Mol % of (PhSiO_{(3-x)/2}(OH)ₓ) units and 50 to 95 Mol % (HSiO_{(3-x)/2}(OH)ₓ), where Ph is a phenyl group, x has a value of 0, 1 or 2 and wherein the cured silicone resin has a critical surface free energy of 30 dynes/cm or higher. These resins are useful as etch stop layers for organic dielectric materials having a critical surface free energy of 40 dynes/cm or higher. The resins are incorporated into a composition, applied and cured in a similar manner as described for the spin-on dielectric resins and compositions described above.

The thermal acid generator of the invention is a compound which, when heated to temperatures of greater than 90° C. and less than 200° C., generates a strong acid. The acid catalyzes the crosslinking of the resin to give a coating which is resistant to solvents used in the coating of photoresists such as propylene glycol monomethyl ether acetate (PGMEA), propylene glycol, monomethyl ether (PGME), and ethyl lactate (EL), as well as alkaline developer used to image the photoresist. More specifically, the thermal acid generator of the invention is a N-benzylpyridinium or N-benzylanilinium salt of a strong acid with, respectively, Formula (I) or (II), 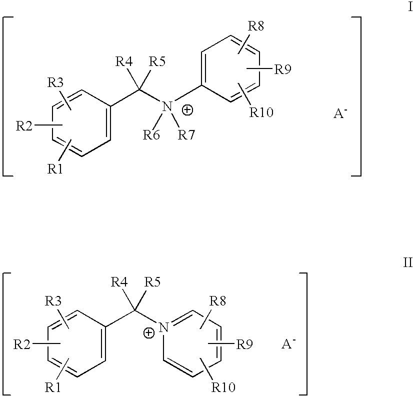
wherein R1, R2, R3, R8, R9 and R10 are independently hydrogen, halogen, alkyl, alkoxy, nitro, amino, alkylamino, cyano, alkoxycarbonyl, or carbamoyl; R4 and R5 are independently hydrogen, alkyl or halogen; R6 and R7 are independently hydrogen or alkyl, wherein the alkyl groups are C₁-C₃ and
A⁻ is selected from the group of the following anions:
   a) an aromatic sulfonate: 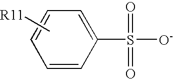
   wherein R11 is alkyl, a perfluoroalkyl, cyano, dialkylamino, alkoxycarbonyl or carbamoyl with C₁-C₄ alkyls;
   b) an alkylated naphthalene sulfonate: 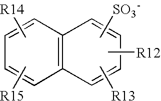
   wherein R12, R13, R14 and R15 are independently hydrogen, alkyl with 1-12 carbons or perfluoroalkyl with 1-8 carbons;
   c) an alkylated naphthalene disulfonate: 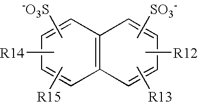
   wherein R12 through R15 are as defined above;
   d) a fluorosubstituted C₁-C₁₂ alkyl sulfonate anion;
   e) a sulfonamide: 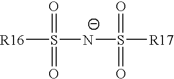
   wherein R16 and R17 are independently an aryl, alkyl, fluorosubstituted aryl, or fluorosubstituted alkyl alkyl is C₁-C₄ alkyl; and
   f) a methide: 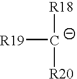
   wherein R18, R19, and R20 are independently H or perfluoroalkyl sulfonyl wherein alkyl is C₁-C₁₂.

The benzylpyridinium and benzylanilinium salt thermal acid generators are particularly useful for forming coatings for applications in microlithography processes related to integrated circuit manufacture. These compounds undergo activation by a mechanism that does not produce any reactive volatile amine or hydroxyl-containing by-products, thereby minimizing the potential for undesirable contamination of fragile circuit components on the wafer, unwanted deposits on internal surfaces of expensive equipment, or atmospheric migration to other compartments of the fabrication process where they can contaminate base sensitive components of the photolithographic process.

At room temperature the salts are stable and non-acidic. While not being bound to any particular mechanism or theory, it is believed that upon heating the quaternary anilinium or quaternary pyridinium cation undergoes a thermal rearrangement whereby the N-benzyl group and the hydrogen in the ortho- or para-position of either the aniline or pyridine ring exchange places as shown in the scheme below. The end result is the production of a strong acid in equilibrium with a weak amine. The key feature is that the amine, N-benzylanilinine or N-benzylpyridine so produced remains intimately associated with the strong acid, is not volatilized during the curing process and does not interfere with the function of the strong acid catalyst.
Catalyst Activation Scheme

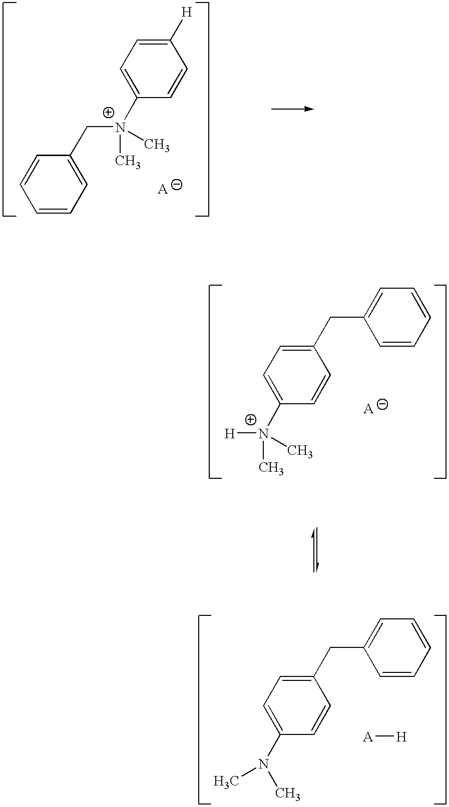

Specific non-limiting examples of thermal acid generators useful in the instant invention are preferably N-(4-methoxybenzyl)-N,N-dimethylanilinium triflate, N-(benzyl)-N,N-dimethylanilinium triflate, N-(benzyl)-N,N-dimethyltoluidinium triflate, N-(4-methylbenzyl)-N,N-dimethylanilinium triflate, N-(4-methoxybenzyl)-N,N-dimethylanilinium dinonylnaphtalenedisulfonate, N-(4-methoxybenzyl)-N,N-dimethylanilinium perfluorooctylsulfonate, N-(4-chlorobenzyl)-N,N-dimethylanilinium perfluorobutylsulfonate, N-(4-methylbenzyl)-N,N-dimethylanilinium bis(trifluoromethylsulfonyl)imide, N-(t-butylbenzyl)-dimethylpyridinium triflate, and N-(4-methoxybenzyl)-N,N-dimethylanilinium tris(trifluoromethylsulfonyl)methide.

The N-benzylanilinium and N-benzylpyridium strong acid salt thermal acid generators of the invention are prepared by the reaction of an quaternary ammonium chloride (substituted or unsubstituted N-benzylanilinium chloride or N-benzylpyridium chloride) with a strong acid in a solvent. The reaction is exothermic. Because the desired thermal acid generators are prone to thermal decomposition, it is common to add one of the reagents slowly to the other to control the temperature of the reaction. There is no set order of addition (i.e., acid to quaternary chloride or visa versa). It is typical to add the acid to the quaternary chloride. In a typical reaction, the strong acid, or a solution of the strong acid in a solvent is added slowly to a suspension or solution of the quaternary ammonium chloride in a solvent. The reaction is carried out at a temperature range of about 25° C. to about 50° C. but more preferably at a temperature of about 20° C. to about 40° C. The addition of the acid to the quaternary ammonium chloride is conducted at a rate and with sufficient cooling to maintain the temperature below 50° C. This is because if the temperature rises above this level, the thermally sensitive quaternary ammonium cation is susceptible to thermal rearrangement. The preferred solvent is a solvent from which the product will precipitate, leaving the by-product hydrochloric acid in solution. Examples of suitable solvents for the reaction include water and lower alcohols such as methanol, ethanol, or isopropanol. In the case where the product precipitates from the reaction solvent, the product can be isolated by filtration. The product should be washed with sufficient solvent until the pH of the rinse is neutral. Excess unreacted acid or the by-product hydrochloric acid left in the product will result in decreased shelf life of the thermal acid generator. The product is dried under vacuum at a temperature not to exceed 50° C. by any of the methods practiced by those familiar with the art. In the instance where the product is soluble in the reaction solvent, the product can be isolated by evaporation of the solvent at reduced pressure at a temperature of between 30° C. to about 50° C. The resulting product may be optionally washed with a solvent in which it has negligent solubility in order to remove any residual hydrochloric acid.

The starting N-benzylanilinium and N-benzylpyridinium chlorides are prepared according to the procedure given in Nakano, et. al., U.S. Pat. No. 5,070,161, Example 1. The general procedure involves addition of either a substituted or unsubstitued dimethylaniline or pyridine to the appropriate substituted or unsubstituted benzyl chloride. The reaction can be carried out in the presence of a solvent but is preferably carried out in the absence of a solvent. The reaction product typically crystallizes over time and is isolated by filtration from the solvent.

The solvents suitable for use in the method for producing the coatings of the present invention are organic solvents. In particular, the solvents that are of low toxicity and additionally have good coating and solubility properties are preferred. The preferred organic solvents that are well known for having low toxicity and are also useful for dissolving the solid components of the present composition, are methanol, propylene gycol monomethyl ether acetate (PGMEA), propylene gycol monomethyl ether (PGME), ethyl lactate (EL), and 2-heptanone, although other low toxicity solvents such as ketones, ethers and alcohols can also be used alone or as mixtures.

For ARCs and BARCs the amount of the hydroxyl-containing resin in the present invention can vary from about 90 wt % to about 50 wt %, preferably about 85 wt % to about 70 wt % and more preferably about 80 wt % to about 70 wt %, relative to the solid portion of the composition. The amount of the crosslinker in the present composition can vary from 5 wt % to about 50 wt %, preferably 15 wt % to about 30 wt % relative to the solid portion of the composition. The amount of the thermal acid generator in the present composition can vary from 0.1 wt % to about 5 wt %, preferably 0.5 wt % to about 3 wt % and more preferably 1 wt % to about 2 wt %, relative to the solid portion of the composition.

The antireflective coating composition comprises the hydroxyl-containing resin, crosslinker and thermal acid generator of the instant invention and a suitable solvent or mixtures of solvents. Other components may be added to enhance the performance of the coating, e.g. monomeric dyes, lower alcohols, surface leveling agents, adhesion promoters, antifoaming agents, etc. Other polymers, such as, NOVOLAK, polyhydroxystyrene, polymethylmethacrylate and polyarylates, may be added to the composition, providing the performance is not negatively impacted. Preferably the amount of this polymer is kept below 50 wt % of the total solids of the composition, more preferably 20 wt %, and even more preferably below 10 wt %.

For underlayer coatings in multiple layer photoresists, the thermally curable polymer composition preferably contains about 75 to 95 wt %, and more preferably about 82 to 95 wt % of hydroxyl containing polymer based on total solids. The amount of the amino cross-linking agent in the thermally curable polymer composition is preferably about 3 to 20 wt % and more preferably about 5 to 15 wt %. The amount of the thermal acid generator in the thermally curable polymer composition is preferably about 0.5 to 5 wt % and more preferably about 1.5 to 3.5 wt %. The composition for preparing the underlayer coatings are dissolved in a solvent at a concentration of 1-20 wt % but more preferably 1-5 wt %.

Compositions useful as positive acting photoresists containing a photobase generator comprise a hydroxyl-containing resin, a crosslinker, a photobase generator and a thermal acid generator. The composition contains about 50 to 95 wt %, preferably about 70-80 wt % of the resin, about 0 to 20 wt %, preferably about 5-10 wt % of the crosslinker; about 0.5 to about 1 wt %, preferably about 0.01 to about 0.5 wt % of the thermal acid generator; and about 0.1 to about 5 wt %, typically about 0.1 to 0.3 wt % of the photobase generator all based on the total solids. The concentration of the compsotion in a solvent as described above is about 5 to 50 wt %, but typically about 15 to 20 wt % of a solvent.

A photobase generator is a neutral compound which produces a base upon exposure to selected radiation. Examples of useful photobase generators for the compositions of the invention can be found in U.S. Pat. No. 5,650,261. Suitable photobase generators which may be used are those which produce an amine base upon exposure and include, for example: benzyl carbamates 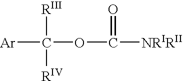
where R^{I} is H, an alkyl group or a substituted alkyl group; and R^{II} is an alkyl group, substituted alkyl group, an aromatic group, or an substituted aromatic group, R^{III}, R^{IV} is an alkyl, substituted alkyl, aryl or substituted aryl group; and Ar is an aryl group;
Carbamates of the structure 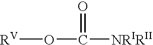
   where R^{I} and R^{II} are as defined above and R^{V}=alkyl, substituted alkyl, aryl or substituted aryl group;
Benzoin carbamates (2-oxo-1,2-diphenylthyl carbamates) of the structure 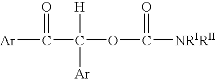
   where R^{I}, R^{II} and Ar are as defined above;
O-carbamoylhydroxylamines 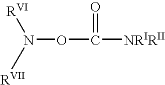
   where R^{I} and R^{II} are as defined above; and R^{VI}, R^{VII}=H, alkyl, substituted alkyl, aryl, substituted aryl, or acyl group;
O-Carbamoyloximes 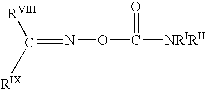
   where RI and RII are as defined above; and RVIII, RIX=H, alkyl, substituted alkyl, aryl, or substituted aryl group;
Aromatic sulfonamides of the structure 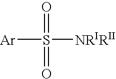
   where R^{I}, R^{II} and Ar are as defined above;
alpha-Lactones 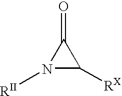
   where R^{II} is as described above and R^{X} is alkyl, substituted alkyl, aryl, or substituted aryl group;
N-(2-Arylethenyl)amides of the structure 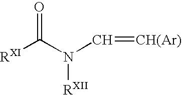
   where R^{XI} is alkyl, substituted alkyl, aryl, or substituted aryl group; R^{II} is alkyl or substituted alkyl group; and Ar is as defined above;
Azides
   ArN₃
   where Ar is aryl or substituted aryl group; and
Formamides 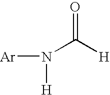
   where Ar is an aryl or substituted aryl group.

For spin-on dielectric coatings the typical composition contains about 5 wt % to about 50 wt %, but more preferable about 5 wt % to about 20 wt %, and typically about 15-20 wt % of the partially condensed hydrogensilsesquioxanes of Formulas 1 to 4 described above in combination with about 0.001 wt % to about 2.0 wt %, but more preferably about 0.1 wt % to about 1.0 wt % of a thermal acid generator in solution.

For spin-on etch stop coatings, the typical composition contains about 5 wt % to about 50 wt %, but more preferable about 5 wt % to about 20 wt %, and typically about 15-20 wt % of the resins described above in combination with about 0.001 wt % to about 2.0 wt %, but more preferably about 0.1 wt % to about 1.0 wt % of a thermal acid generator in a solvent.

For ARCs, BARCs and underlayer coatings for multiple layer photoresists, the coating composition is coated on the substrate using techniques well known to those skilled in the art, such as dipping, spin coating or spraying. The film thickness of the antireflective coating ranges from about 20 nm to about 1000 nm, more preferably about 20 nm to about 500 nm and most preferably about 20 nm to about 200 nm. The optimum film thickness is determined, as is well known in the art, to be where no standing waves are observed in the photoresist.

The coating is further heated on a hot plate or convection oven for a sufficient length of time to remove any residual solvent and induce crosslinking, and thus insolubilizing the antireflective coating to prevent intermixing between the antireflective coating and the photoresist layer. The heating may be conducted in a single step but is often more preferably conducted in more than one step and most preferably conducted in 2 steps to reduce the potential for premature crosslinking of the resin before all of the solvent has evaporated which could lead to an irregular coating surface or undesirable pin holes in the coating.

In the first step, the coating is heated at such a temperature that is high enough to sufficiently remove all of the solvent but is low enough that it does not activate a substantial portion of the thermal acid generator and cause crosslinking of the film. The lower temperature cure (sometimes referred to as a soft bake) is typically carried out a temperature between 50° C. and 100° C. but is more preferably carried out at a temperature of between 50° C. and 90° C.

The time for the low temperature cure will depend on the solids content of the composition and is in the range of 60 seconds to 5 minutes and preferably in the range of 60 seconds to 180 seconds. Once the solvent has been sufficiently removed from the coating the remaining composition is heated at a higher temperature that results in activation of the thermal acid generator and sufficient crosslinking of the film to make it resistant to solvents used in the coating of photoresists such as propylene glycol monomethyl ether acetate (PGMEA), propylene glycol, monomethyl ether (PGME), and ethyl lactate (EL), as well as alkaline developer used to image the photoresist. The higher temperature cure is conducted at about 90° C. and 250° C. with a more preferred temperature range of about 100° C. to about 200° C. At temperatures above 250° C. the composition may become sufficiently unstable.

The instant invention also further comprises a method for producing an antireflective coating by a photolithographic process comprising coating a substrate with the antireflective coating and heating on a hotplate or convection oven at a sufficiently high temperature for sufficient length of time to remove the coating solvent, and crosslink the polymer to a sufficient extent so that the coating is not soluble in the coating solution of the photoresist or in the aqueous alkaline developer. An edge bead remover may be applied to clean the edges of the substrate using processes well known in the art. The preferred range of temperature is from about 90° C. to about 250° C. A film of photoresist is then coated on top of the antireflective coating and baked to substantially remove the photoresist solvent. The photoresist is imagewise exposed and developed in an aqueous developer to remove the treated photoresist. The developer is preferably an aqueous alkaline solution comprising, for example, tetramethyl ammonium hydroxide. An optional heating step can be incorporated into the process prior to development and after exposure.

The process of coating and imaging photoresists is well known to those skilled in the art and is optimized for the specific type of resist used. The patterned substrate can then be dry etched in a suitable etch chamber to remove the exposed portions of the antireflective film, with the remaining photoresist acting as an etch mask.

An intermediate layer may be placed between the antireflective coating and the photoresist to prevent intermixing, and is within the scope of this invention. The intermediate layer is an inert polymer cast from a solvent, where examples of the polymer are polysulfones and polyimides.

Photoresists can be any of the types used in the semiconductor industry, provided the photoactive compound in the photoresist and the antireflective coating absorb at the exposure wavelength used for the imaging process. There are two types of photoresist compositions, negative-working and positive-working. When negative-working photoresist compositions are exposed image-wise to radiation, the areas of the resist composition exposed to the radiation become less soluble to a developer solution (e.g. a cross-linking reaction occurs) while the unexposed areas of the photoresist coating remain relatively soluble to such a solution. Thus, treatment of an exposed negative-working resist with a developer causes removal of the non-exposed areas of the photoresist coating and the creation of a negative image in the coating, thereby uncovering a desired portion of the underlying substrate surface on which the photoresist composition was deposited.

On the other hand, when positive-working photoresist compositions are exposed to radiation to form an image, those areas of the photoresist composition exposed to the radiation become more soluble to the developer solution (e.g. a rearrangement reaction occurs) while those areas not exposed remain relatively insoluble to the developer solution. Thus, treatment of an exposed positive-working photoresist with the developer causes removal of the exposed areas of the coating and the creation of a positive image in the photoresist coating. Again, a desired portion of the underlying surface is uncovered.

Positive working photoresist compositions are currently favored over negative working resists because the former generally provide better resolution and pattern transfer characteristics. Photoresist resolution is defined as the smallest feature that the resist composition can transfer from the photomask to the substrate with a high degree of image edge acuity after exposure and development. In many manufacturing applications today, resist resolution on the order of less than one micron are necessary. In addition, it is almost always desirable that the developed photoresist wall profiles be near vertical relative to the substrate. Such demarcations between developed and undeveloped areas of the resist coating translate into accurate pattern transfer of the mask image onto the substrate. This becomes even more critical as the push toward miniaturization reduces the critical dimensions on the devices.

Photoresists sensitive to short wavelengths, between about 130 nm and about 250 nm can also be used where sub-half-micron geometries are required. Particularly preferred are photoresists comprising non-aromatic polymers, a photoacid generator, optionally a solubility inhibitor, and solvent. Photoresists sensitive at 193 nm that are known in the prior art are described in the following references and incorporated herein, EP 794458, WO 97/33198 and U.S. Pat. No. 5,585,219, although any photoresist sensitive at 157 nm, 193 nm or 248 nm may be used on top of the antireflective compositions of this invention.

Methods of the present invention for preparing fully condensed silsesquioxane-based inner layer dielectric layers typically employ spin coating techniques for application of films. It is well known to one of ordinary skill in the art that semiconductor substrates are currently available in a variety of sizes ranging from as small as three or four inches in diameter to as large as twelve inches in diameter. Therefore, it will be understood that the process parameters presented hereinafter are for a four inch or six inch wafer and are for illustrative purposes only. Thus, modifications to the volume of material, solution concentration, rotational speeds or the various times described below are appropriate for any specific application. It will be further understood, therefore, that all such modification are within the scope and spirit of the present invention.

A solution of organohydridosiloxane resin and thermal acid generator is prepared by combining the two ingredients in an appropriate solvent. Typically, such resin solutions are approximately 5 wt % to 35 wt % resin and about 0.001 to about 1.0 wt % thermal acid generator. Advantageously, methyl isobutyl ketone (MIBK), heptane, dodecane, butyl ether, butyl acetate, isobutyl acetate, propyl acetate or a blend of hexamethyldisiloxane, octamethyltrisiloxane, and octamethylcyclotetrasiloxane, or combinations thereof are useful as solvents, although other appropriate solvents may also be employed. Prior to use, the solvents are preferably dried over 3 ANG or 4 ANG molecular sieves.

The resulting solution is then filtered under ambient conditions via any of the filtration devices well known in the art. It is generally preferable to use a filtration device having a pore size less than about 1 μm. A typical filtration process uses a pore size of about 0.1 μm.

In the spin coating process, the organohydridosiloxane resin solution prepared in the manner described above is dispensed onto a wafer at or near its center. In some embodiments, the wafer will remain stationary during the dispense cycle, while in some embodiments, the wafer will turn or spin at a relatively low speed, typically less than about 500 revolutions per minute (rpm). The dispense cycle is followed by a short rest period and then additional spins, hereinafter referred to as thickness spins, generally between approximately 2000 and 3000 rpm, although other spin speeds may be used, as appropriate.

Once the coating process is completed, the substrate coated with the resin solution, is heated to affect a bake process and a subsequent cure process. The bake process removes the solvent, causes the polymer to flow, activates the thermal acid generator and begins the conversion of the coating to the dielectric film. The cure process completes the conversion of the coating to the dielectric film. Any conventional apparatus known in the art can be employed for these processes.

Preferably, the apparatus for the bake process is an integral part of a spin coating apparatus used for coating the substrate or wafer, although a separate apparatus for curing coatings applied in accordance with embodiments of the present invention is also suitable. The bake process can be carried out in an inert atmosphere such as an atmosphere of an inert gas, nitrogen, or nitrogen/air mixture. One commonly employed heating apparatus employs one or more “hot plates” to heat the coated wafer from below. The coated wafer is typically heated for up to about 120 sec at each of several hot plates at successively higher temperatures. In the absence of a thermal acid generator the hot plates are at temperatures between about 70° C. and 350° C. In the presence of a thermal acid generator the highest temperature oven can be decreased to the range of 225-250° C. One typical process employs a heating apparatus having three hot plates. First, the wafer is baked for about 60 sec at 150° C. Then the wafer is transferred to a second hot plate for an approximately 60 sec bake period at 200° C. Finally, the wafer is transferred to a third hot plate for a third bake period of approximately 60 sec at 250° C.

A final short high temperature cure process is preferably employed to complete the curing of the film and to decompose and volatilize the organic thermal acid generator as it is no longer required since any residual organics will adversely affect it insulating properties. The cure is preferably performed in an inert atmosphere, as described above for the bake process. This final cure process can employ a conventional thermal curing apparatus, for example a horizontal furnace with a temperature range of about 300° C. to about 450° C. and preferably from about 375° C. to about 425° C. In a typical furnace cure process, the baked wafer is cured for 30 minutes to one hour at 400° C. at a nitrogen flow rate of 4 liters/min to 20 liters/min.

Alternatively, the cure process can employ a high-temperature hot plate curing module which has an oxygen-density-controlled environment. In this process, the baked wafer is cured on a hot plate at a temperature between about 400° C. and 450° C. for a period of from about 1 to about 15 minutes in a nitrogen or inert atmosphere with an oxygen density of less than about 100 parts per million. For example, a suitable cure atmosphere is achieved with a nitrogen flow rate of between about 10 and about 30 liters/min. It will be understood that the above bake and cure processes were described for illustrative purposes only and that other temperatures, durations, and number of bake cycles can be employed, where appropriate.

The following examples illustrate the synthesis and function of the invention.

The N-benzylanilinium and N-benzylpyridinium chlorides used in the preparation of Examples 1A-1F were prepared according to the procedure given in Nakano, et. al., U.S. Pat. No. 5,070,161, Example 1. The procedure generally involves addition of either dimethylaniline or pyridine to the appropriate substituted or unsubstituted benzyl chloride. The reactions can be carried out in the presence of a solvent but is preferably carried out in the absence of a solvent. The reaction product typically crystallizes over time and is isolated by filtration from the liquid raw materials.

### EXAMPLE 1A

### N-(4-METHOXYBENZYL)-N,N-DIMETHYLANILINIUM TRIFLUOROMETHANESULFONATE

100 g (0.3493 mol) of N-(4-methoxybenzyl)-N,N-dimethylanilinium chloride and 300 g of water were added to a 4 neck reaction flask. The flask is equipped with a mechanical stirrer, thermocouple probe, a cool water condenser, and a nitrogen sweep. 48.25 g (0.3151 mol) of trifluoromethanesulfonic acid was added to the suspension of anilinum chloride in water over a 1 hour period using a pressure equalizing addition funnel. The temperature was monitored not to exceed 40° C. The N-(4-Methoxybenzyl)-N,N-dimethylanilinium triflate precipitates as the reaction proceeds. When the addition of trifluoromethanesulfonic acid is complete, the reaction mixture was stirred for ½ hour. The N-(4-Methoxybenzyl)-N,N-dimethylanilinium triflate was filtered from the aqueous phase, and the product was washed with an excess of water until the pH of the rinse water ranges from 5-6. The N-(4-Methoxybenzyl)-N,N-dimethylanilinium Triflate was dried in vacuo for 3 hours to give 106.5 grams (86% yield) of a white powder with a melting point of 118-120° C. ¹H NMR (400 MHz)(d₆-DMSO): δ 3.5 (s, 6H, N(CH₃)₂), 3.75 (s, 3H, ArOCH₃), 4.93 (s, 2H, benzylCH₂), 6.84 (m, 2H, ArH), 6.95 (m, 2H, ArH), 7.58 (m, 3H, ArH), 7.80 (m, 2H, ArH). ¹³C NMR (175 MHz)(d₆-DMSO): δ 52.7 (N(CH₃)₂), 55.5 (ArOCH₃), 72.4 (benzylC), 114.4, 120.3, 122.2, 130.4, 130.6, 134.4, 144.9, 161.1 (ArC).

### EXAMPLES 1B-1F

Examples 1B-1F were prepared using the general procedure of Example 1A from the appropriate quaternary ammonium chlorides and acids shown in Table 1. The reaction yields, and spectroscopic data are reported in Table 2. In the case of Example 1F the product was a viscous liquid and was isolated by simply separating the insoluble liquid product from the aqueous reaction mixture

TABLE 1
Reagent Charges for Synthesis of Examples 1B-1F

| | Quaternary ammonium | | |
|---|---|---|---|
| Sample | chloride | Acid | Product |
| 1B | 60.0 grams | 20.0 grams | N-(benzyl)-N,N- |
| | N-(benzyl)-N,N- | Trifluoromethane | dimethylanilinium triflate |
| | dimethylanilinium chloride | sulfonic acid | |
| 1C | 26.0 grams | 8.7 grams | N-(4-methylbenzyl)-N,N- |
| | N-(4-methylbenzyl)-N,N- | Trifluoromethane | dimethylanilinium triflate |
| | dimethylanilinium chloride | sulfonic acid | |
| 1D | 100.0 grams | 107.0 grams | N-(benzyl)-N,N- |
| | N-(benzyl)-N,N- | Trifluoromethane | dimethyltoluidinium triflate |
| | dimethyltoluidinium chloride | sulfonic acid | |
| 1E | 25.0 grams | 24.4 grams | N-(4-nitrobenzyl)-N,N- |
| | N-(methoxybenzyl)-N,N- | Nonafluorobutyl | dimethylanilinium nonaflate |
| | dimethylanilinium chloride | sulfonic acid | |
| 1F | 14.6 grams | 9.2 grams | N-(4-methoxybenzyl)-N,N- |
| | N-(4-methoxybenzyl)-N,N- | Trifluoromethane | dimethylpyridinium triflate |
| | dimethylpyridinium chloride | sulfonic acid | |

TABLE 2
Physical and Spectroscopic Data for Examples 1B-1F.

| | Melting Point | | |
|---|---|---|---|
| Example | (° C.) | ¹H NMR (400 MHz) (d₆-DMSO) | Yield (%) |
| 1B | 95 | δ 3.58(s, 6H, N(CH₃)₂), 5.03(s, 2H, benzylCH₂), | 69 |
| | | 7.02(d, 2H, ArH), 7.36(t, 2H, ArH), 7.53(t, 1H, ArH), | |
| | | 7.62(m, 3H, ArH), 7.84(d, 2H, ArH) | |
| 1C | 86 | δ 2.24(s, 3H, ArCH₃) 3.58(s, 6H, N(CH₃)₂), | 72 |
| | | 4.99(s, 2H, benzylCH₂), 6.92(d, 2H, ArH), | |
| | | 7.15(d, 2H, ArH), 7.62(m, 3H, ArH), 7.84(d, 2H, ArH) | |
| 1D | 134 | δ 2.28(s, 3H, ArCH₃) 3.58(s, 6H, N(CH₃)₂), | 66 |
| | | 5.00(s, 2H, benzylCH₂), 7.06(d, 2H, ArH), | |
| | | 7.37(m, 2H,ArH), 7.42(m, 3H, ArH), 7.74(d, 2H, ArH) | |
| 1E | 111 | δ 3.55(s, 6H, N(CH₃)₂), 3.73(s, 3H, ArOCH₃) | 95 |
| | | 4.96(s, 2H, benzylCH₂), 6.88(d, 2H, ArH), | |
| | | 6.96(d, 2H, ArH), 7.60(m, 3H, ArH), 7.82(d, 2H, ArH) | |
| 1F | Viscous liquid, | δ 3.76(s, 3H, ArOCH₃) 5.78(s, 2H, benzylCH₂), | 36 |
| | water insoluble | 6.99(d, 2H, ArH), 7.54(d, 2H, ArH), 8.18(m, 2H, ArH), | |
| | | 8.60(t, 1H, ArH), 9.18(d, 2H, ArH) | |

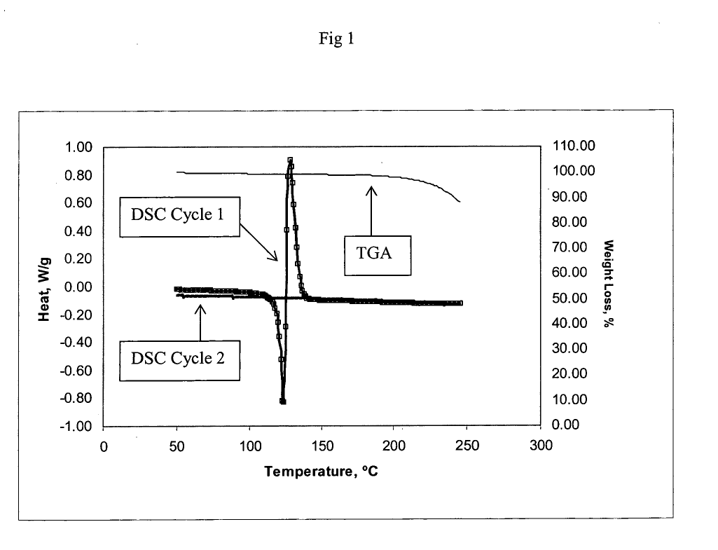

The unique activation and low volatility of the active complexes of the thermal acid generators of the invention is demonstrated in the concurrent differential scanning calorimetry and thermal gravimetric analysis results shown in FIG. 1 for N-(4-methoxybenzyl)-N,N-dimethylanilinium triflate. For this analysis a TA Instruments model # 2050 TGA and TA Instruments model # 2010 DSC were used. The results of DSC cycle 1 shows a sharp endotherm (negative peak) at 115-120° C. due to melting of the solid followed by an immediate exotherm (positive peak) at 130-135° C. due to the rearrangement of the cation. The concurrent TGA shows that there is little to no weight loss in the sample during the rearrangement. Significant weight loss (refer to right hand Y scale) is not observed below 200° C. When the sample is cooled and then reheated through a second DSC cycle there is no endotherm or exotherm. The chemically rearranged and chemically active complex is a waxy solid and thus does not possess a melting point. The lack of exotherm observed in DSC cycle 2 demonstrates that the chemical rearrangement is irreversible.

### EXAMPLE 2A

### Antireflective Coating from Poly(4-hydroxystyrene), an Amino Crosslinker and the Thermal Acid Generator of Example 1A

An antireflective coating composition was made by dissolving 7.0 g of poly(4-hydroxystyrene), 2.09 g of tetrakis(methoxymethyl)glycoluril (Powderlink® 1174 available from Cytec Industries, West Paterson, N.J.), 0.8 g of a 12.5 wt % solution of the thermal acid generator of Example 1A in methanol and 27 g of ethyl lactate. The solution was filtered through 0.45 and 0.2 μm filters.

The antireflective coating formulation was evaluated for both storage stability (shelf life) and cure profile (cure as a function of both time and temperature). The storage stability of the formulation was determined by placing 10 grams in a closed 2 dram glass vial and then visually inspecting for any changes in color or viscosity after standing for 24 hours at room temperature. The formulation was inspected a second time after 1 month. The results are reported in Table 4.

The formulation of Example 2A was evaluated for cure by the following general procedure. Standard glass microscope slides (0.75″×3″) were dipped into the formulation and then hung in the open air to dry for 15 minutes. The glass slide possessing a thin coating of the antireflective formulation was then cured in an oven for a specific time period and at a specific temperature. The slide was then allowed to cool for 15 minutes and then ½ of the coated slide was immersed in ethyl lactate. The slide was removed from the ethyl lactate after 5 minutes, allowed to dry for 15 minutes and then visually inspected under 10× magnification for coating integrity. Two levels of cure were distinguishable. No cure is defined as a coating that is completely dissolved by exposure to ethyl lactate for 5 minutes. Full cure is defined as a coating film that shows no indication of damage after 5 minutes of exposure to the ethyl lactate. The minimum temperature and time where full cure was observed for each of the antireflective coatings formulations are shown in Table 4.

### EXAMPLES 2B-E

### Antireflective Coatings from Poly(4-hydroxystyrene), an Amino Crosslinker and the Tags of Example 1B-E

Formulations similar to that of Example 2A were prepared using the same amounts of each of the reagents except that 12.5 wt % solutions of each of the catalysts of Examples 1B-E in methanol were substituted for the catalyst solution of Example 1A in each of the respective formulations 2B-2E. The formulations were evaluated for both storage stability and cure described above for Example 2A and the results are reported in Table 4.

### COMPARATIVE EXAMPLES 2F-L

### Comparative Antireflective Coatings from Poly(4-Hydroxystyrene), an Amino Crosslinker

Formulations similar to that of Example 2A were prepared using the same amounts of each of the components used in Example 2A except that 12.5 wt % methanolic solutions of each of the catalysts shown in Table 3 were used in place of the 12.5 wt % methanol solution of Example 1A for each of formulations 2F-2L. The formulations were evaluated for storage stability and cure using the procedures described for Example 2A above.

TABLE 3
Comparative Thermal Acid Generators and Respective Example
Antireflective Formulations

| Comparative | | Thermal Acid Generator |
|---|---|---|
| Example | Thermal Acid Generator | Type |
| 2F | Dodecylbenzene sulfonic | No Blocking Group |
| | acid | |
| 2G | Ammonium Triflate | Amine Sulfonate |
| 2H | Cyclohexyl Tosylate | Sulfonic Acid Ester |
| 2I | 2-Nitrobenzyl Tosylate | Sulfonic Acid Ester |
| 2J | 4-Nitrobenzyl Tosylate | Sulfonic Acid Ester |
| 2K | Phthalimidyl Tosylate | Sulfonic Acid Ester |
| 2L | Pyridinium Tosylate | Amine Sulfonate |

### Evaluation of the Antireflective Coating Examples 2A-2L

Two critical performance attributes of an antireflective coating used in microlithography are shelf life stability and resistance to photoresist formulation solvents and resist developer chemicals after cure. The coating formulation prior to use must be stable at room temperature and must not undergo any crosslinking. Even a small amount of premature crosslinking during storage prior to use will result in an increase in viscosity of the formulation which will eventually lead to a final coating (after spin coating and cure) that is thicker than desired. Premature crosslinking can also lead to coating defects on the wafer and/or poor solvent resistance after cure. If significant crosslinking occurs during storage the formulation may gel. Resistance to resist solvents after cure is important to prevent removal of the antireflective coatings during subsequent coating of the resist. In addition, the coating must not be soluble in the solvents used to develop the resist after exposure since this will lead to undercutting of the resist pattern and delamination of the resist coating.

TABLE 4
Stability and Cure Data for Antireflective Coatings of Examples
2A-E and Comparative Examples 2F-L

| | Condition after 24 | Minimum Cure | Minimum Cure |
|---|---|---|---|
| Formulation | hours at rt | Temp., ° C. | Time in Minute) |
| 2A | No change | 175 | 15 |
| 2B | No change | 200 | 15 |
| 2C | No change | 175 | 15 |
| 2D | No change | 200 | 15 |
| 2E | No change | 175 | 15 |
| Comparative 2F | Gelled | 75 | 15 |
| Comparative 2G | No change | 125 | 60 |
| Comparative 2H | No change | 100 | 15 |
| Comparative 2I | No change | 125 | 15 |
| Comparative 2J | No change | 125 | 15 |
| Comparative 2K | No change | 150 | 60 |
| Comparative 2L | No change | 150 | 30 |

The results reported in Table 4 demonstrate that the formulations containing the latent catalysts of the invention are stable and have good shelf lives at room temperature. These formulations also providee solvent resistant crosslinked films after thermal cure. The thermal acid generators of the present invention also provide improved cure response (a higher temperature of activation) than prior art amine sulfonate and sulfonic acid ester type thermal acid generators.

### EXAMPLE 3

### Illustration of an Antireflective Resin Particularly Suitable for 193 nm Photoresist Containing Aromatic Functionality

A polyester resin particularly suitable for a 193 nm photoresist antireflective coating was prepared according to the procedure reported in Wayton, G. B., et. al., U.S. Pat. No. 6,852,241, Example 2 with some modification as described below.

Dimethyl isophthalate (74.0 g, 380 mmol), dimethyl phthalate (8.4 g, 48.0 mmol), glycerol (19.2 g, 208 mmol), 1,3,5-tris(2-hydroxyethyl)isocyanuric acid (62.0 g., 238 mmol) and p-toluenesulfonic acid monohydrate (PTSA) (1.6 g, 8.0 mmol) were charged to a 250-mL three-neck, round-bottom flask equipped with a mechanical stirrer, temperature control box, temperature probe, heating mantle, condenser, Dean-Stark trap, and nitrogen purge inlet (sweep). The reaction was heated at 160° C. for 5 hours during which time 15 mL of methanol was collected in the Dean-Stark trap. The reaction was cooled to 60° C. at which point it solidified and stirring was stopped. To the resultant polymer was added 50 mL tetrahydrofuran (THF). The polymer dissolved in the tetrahydrofuran over a 2 day period. The polymer was then precipitated by pouring the polymer/THF solution into 1 liter of 2-propanol with vigorous agitation. The resulting white solid polymer was collected by filtration in a Buchner funnel, air-dried, and then dried in vacuo between 40-70° C. The dry polymer was analyzed by gel permeation chromatography and gave a Mn of 1585, a polydispersity index (PDI) of 2.03 and a hydroxyl number of 137 mg KOHI/g.

### EXAMPLE 4A

### Preparation of a Thermally Curable Antireflective Coating Formulation for 193 NM Lithography Using the Resin of Example 3 and the Thermal Acid Generator of Example 1A

A thermally curable antireflective coating suitable for a 193 nm lithography with 20.2 wt % total resin solids (resin+crosslinker) was formulated by combining 50.0 grams of the polymer of Example 3, 13.15 grams of tetramethoxymethyl glycoluril (available from Cytec as POWDERLINK® 1174), 250 grams of ethyl lactate, and 1.26 grams of N-(4-methoxybenzyl)-N-N-dimethylanilinium triflate of Example 1A. The mixture was rolled until homogeneous. The resulting formulation was a homogeneous liquid. The formulation was evaluated for cure as described below and the results compared to that of Examples 4B-4E and Comparative Example 4F in Table 5.

### EXAMPLES 4B-E

Formulations similar to that of Example 4A were prepared using the same amounts of each component of Example 4A except that the catalysts of Examples 1B-E were substituted for the catalyst of Example 1A in each of the respective formulations 4B-4E. The formulations were evaluated for cure as described below and the results compared to that of Example 4A and Comparative Example 4F in Table 5.

### COMPARATIVE EXAMPLE 4F

A formulation similar to that of Example 4A was prepared using the same amount of resin, crosslinker and solvent except that 1.25 grams of dodecylbenzene sulfonic acid was used in place of the catalyst of Example 1A.

### COMPARATIVE EXAMPLE 4G

A formulation similar to that of Example 4A was prepared using the same amount of resin, crosslinker and solvent but with no catalyst.

### Evaluation of Cure for Thermally Curable Antireflective Coating Suitable for 193 NM Lithography

The formulations of Examples 4A-G were evaluated for cure by the following general procedure. Approximately 2.0 mL of the formulation were placed as a 3 inch line at the top of the long edge of a 4″×6″ glass plate. The formulation was drawn down the plate using a standard #10 coatings draw down bar. The coating was allowed to air dry for 15 minutes and then placed in an oven at a specific temperature for 15 minutes. After removal from the oven the film was allowed to cool at room temperature for 15 minutes. The final thickness of the cured underlayer coatings was determined using a Byk Trigloss Specular gloss meter to be approximately 1500 nanometers.

An ethyl lactate puddle test was used to test the degree of cure of the thermally treated coatings. A 0.30 mL drop of ethyl lactate was then placed on the coating using a micropipette. The drop was allowed to sit on the coating for 5 minutes and then the coating was wiped with a sterile cloth. The spot on the coatings where the solvent was puddled was visually examined at 10× magnification for any signs of damage. Three levels of cure were distinguishable. No cure is defined as a coating that is completely dissolved by exposure to ethyl lactate for 5 minutes. Partial cure (or cure onset) is defined as a film that maintains its integrity but shows signs of marring, scuffing, or staining due to exposure to the ethyl lactate after cure. Full cure is defined as a coating film that shows no indication of damage after exposure to the ethyl lactate. The minimum temperature where onset of cure and full cure were observed in the ethyl lactate puddle test for formulations 4A-G is shown in Table 5.

TABLE 5
Minimum Temperature for Onset Cure and Full Cure for Thermally
Curable Antireflective Coating Particularly Suitable for 193 nm
Lithography as a Function of Catalyst

| | | | Full Cure | |
|---|---|---|---|---|
| Underlayer | | Partial Cure | Temp., | Difference, |
| Formulation | Catalyst | Temp., ° C. | ° C. | ° C. |
| Example 4A | Example 1A | 125 | 140 | 15 |
| Example 4B | Example 1B | 165 | 180 | 15 |
| Example 4C | Example 1C | 165 | 200 | 35 |
| Example 4D | Example 1D | 180 | 210 | 25 |
| Example 4E | Example 1E | 125 | 140 | 15 |
| Comparative | Dodecylbenzene | 75 | 100 | 25 |
| Example 4F | sulfonic acid | | | |
| Comparative | No catalyst | — | No cure at | — |
| Example 4G | | | 210° C. | |

### EXAMPLE 5A

### Preparation of a Thermally Activatable Cation-Polymerizable Underlayer Coating

A thermally activatable cation-polymerizable underlayer coating was prepared by combining 10 grams of a cycloaliphatic diepoxide of structure: 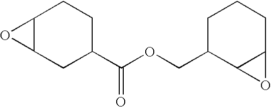
(available from Dow Chemical Company as ERL 4221) and 0.4 grams of a 25 wt % solution of the catalyst of Example 1A in propylene carbonate. The formulation is stable (i.e., does not undergo cure) indefinitely at room temperature.

### EXAMPLES 5B-5E

Formulations similar to that of Example 5A were prepared using the same amounts of each component of Example 5A except that 25 wt % solutions of the catalysts of Examples 1B-E were substituted for the solution of Example 1A in propylene carbonate in each of the respective formulations 5B-5E.

### COMPARATIVE EXAMPLE 5F

A control thermally activatable cation-polymerizable underlayer coating was prepared by combining 10.0 grams or ERL 4221 cycloaliphatic diepoxide with 0.4 grams of propylene carbonate.

### Evaluation of Cure for the Thermally Activatable Cation-Polymerizable Underlayer Coatings of Examples 5A-5E

The cure of the thermally activatable cation-polymerizable underlayer coatings was evaluated using differential scanning calorimetry (DSC) using the following general procedure.

A small quantity (15-20 mg) of the formulation was weighed into a DSC open top aluminum pan and placed in the load cell of a TA Instruments model 2010 Differential Scanning Calorimeter. The sample was heated at 5° C. per minute while monitoring the heat absorbed or emitted from the system. The temperature at which the first sign of an exotherm was detected is taken as the cure onset. The temperature at which the exotherm of the polymerization reaches its peak is taken as the peak exotherm temperature. Both temperatures provide an indication of the temperature of activation of the thermal acid generator. The results are reported in Table 6.

TABLE 6
Cure Onset and Peak Exotherm Temperatures for a Thermally
Activatable Cation-polymerizable Underlayer Coating

| | | Cure | |
|---|---|---|---|
| Formulation | Catalyst Example | Onset (° C.) | Peak Exotherm (° C.) |
| 5A | 1A | 111 | 135 |
| 5B | 1B | 159 | 171 |
| 5C | 1C | 151 | 165 |
| 5D | 1D | 162 | 175 |
| 5E | 1E | 166 | 178 |
| 5F (control) | No catalyst | No onset | No exotherm |

The results reported in Table 6 demonstrate that the combination of the cycloaliphatic diepoxide and the thermal acid generators of the invention provides thermally activatable cation-polymerizable coating formulations that are stable at room temperature but readily undergo cure upon heating. The activation temperature of the formulation can be controlled or specified by proper choice of thermal acid generator. The formulation does not undergo cure in the absence of the thermal acid generator.

### EXAMPLE 6

### Synthesis of a Resin Useful as an Underlayer for 193 NM Multiple Layer Photoresist

The preparation of the resin useful as an underlayer for a 193 nm multiple layer photoresist was taken from Foster, et. al., U.S. Pat. No. 6,054,248.

In a 100 ml three-necked round bottom flask equipped with a magnetic stir bar, addition funnel, condenser, and nitrogen inlet-outlet is added a mixture of 49.0 g of isobornyl methacrylate, 13.0 g of 2-hydroxyethyl methacrylate, 100 ml of tetrahydrofuran (THF) and 1.0 g of 2,2′-azobis(2-methylbutyronitrile). The mixture is heated to 65° C. and stirred for 13 hours. The solution is precipitated by addition to 2 liter of heptane. The precipitate is filtered, and the solid dried at 4 mbar for 24 hours. The yield of polymer was 59.2 grams.

Molecular weights and molecular weight distributions are measured using a Waters Corp. liquid chromatograph. The number average molecular weight (Mn) was 32,810 and the polydispersity (Mw/Mn) was 1.13. The hydroxyl number was 93.3 mg KOH/gram.

### EXAMPLE 7A

### Thermally Curable Composition as an Underlayer for 193 NM Multiple Layer Photoresist Using Resin of Example 6 and Thermal Acid Generator of Example 1A

A thermally curable composition with 20 wt % total resin solids (resin+crosslinker) was formulated by combining 56.8 grams of the polymer of Example 7, 10.15 grams of tetramethoxymethyl glycoluril (available from Cytec as POWDERLINK® 1174), 268 grams of ethyl lactate, and 1.33 grams of N-(4-methoxybenzyl)-N-N-dimethylanilinium triflate of Example 1A. The mixture is rolled overnight, and the solution for the undercoat was filtered twice through a 0. μm Teflon filter.

### EXAMPLES 7B-E

Formulations similar to that of Example 7A were prepared using the same amounts of each component of Example 7A except that the catalysts of Examples 1B-E were substituted for the catalyst of Example 1A in each of the respective formulations 7B-8E.

### COMPARATIVE EXAMPLE 7F

### Thermally Curable Composition as an Underlayer for 193 NM Multiple Layer Photoresist Using Resin of Example 6 with Dodecylbenzene Sulfonic Acid as Catalyst

A thermally curable composition with 20 wt % total resin solids (resin+crosslinker) was formulated by combining 56.8 grams of the polymer of Example 6, 10.15 grams of tetramethoxymethyl glycoluril (available from Cytec as POWDERLINK® 1174), 268 grams of ethyl lactate, and 1.68 grams of dodecylbenzene sulfonic acid (available from Stepan Chemical as Biosoft® 400S). The mixture was rolled for 30 minutes at room temperature.

### COMPARATIVE EXAMPLE 7G

### Underlayer for 193 NM Multiple Layer Photoresist Using Resin of Example 6 with an Amine Salt of Dodecylbenzene Sulfonic Acid as the Latent Catalyst

A thermally curable composition with 20 wt % total resin solids (resin+crosslinker) was formulated by combining 56.8 grams of the polymer of Example 6, 10.15 grams of tetramethoxymethyl glycoluril (available from Cytec as POWDERLINK® 1174), 268 grams of ethyl lactate, and 6.7 grams of a 25 wt % solution of an amine salt of dodecylbenzene sulfonic acid (available from King Industries, Inc. as NACURE® 5225). The mixture was rolled for 30 minutes at room temperature.

### Evaluation of Underlayer Formulation Stability

The stability of the formulations (Examples 7A-G) was determined by placing 10 grams of the formulation in a closed 2 dram glass vial. The vials were visually inspected for any changes in color or viscosity after standing for 24 hours at room temperature. The formulations were inspected a second time after 1 month. The results are reported in Table 7.

TABLE 7
Formulation Stability (Shelf-Life) of Underlayer Formulations for
193 nm Multiple Layer Photoresist

| | | 24 hrs at rt in closed | 30 days at rt in |
|---|---|---|---|
| Formulation | Catalyst | vial | closed vial |
| Example 7A | Example 1A | Unchanged, | Unchanged, |
| | | homogeneous liquid | homogeneous |
| | | | liquid |
| Example 7B | Example 1B | Unchanged, | Unchanged, |
| | | homogeneous liquid | homogeneous |
| | | | liquid |
| Example 7C | Example 1C | Unchanged, | Unchanged, |
| | | homogeneous liquid | homogeneous |
| | | | liquid |
| Example 7D | Example 1D | Unchanged, | Unchanged, |
| | | homogeneous liquid | homogeneous |
| | | | liquid |
| Example 7E | Example 1E | Unchanged, | Unchanged, |
| | | homogeneous liquid | homogeneous |
| | | | liquid |
| Comparative Example | Dodecylbenzene sulfonic | Gelled | — |
| 7F | acid | | |
| Comparative Example | Amine Salt of | Unchanged, | More viscous than |
| 7G | Dodecylbenzene Sulfonic | homogeneous liquid | original |
| | Acid | | formulation |

The results shown in Table 7 demonstrate that the latent catalysts of the invention are inactive in the formulation at room temperature and impart excellent shelf life to the thermally curable underlayer formulations. The formulation made with dodecylbenzene sulfonic acid (Example 7F) undergoes partial cure and gelling after only 24 hours. The formulation made with the amine sulfonate latent catalyst possesses short term stability and shows signs of partial crosslinking of the formulation components over longer storage periods.

### Evaluation of Cure for the Thermally Curable Composition Useful as an Underlayer for 193 NM Multiple Layer Photoresist

The formulations of Examples 7A-E along with Comparative Example 7F-G were evaluated for cure by the following general procedure. Approximately 2.0 mL of the formulation were placed as a 3 inch line at the top of the long edge of a 4″×6″ glass plate.

The formulation was drawn down the plate using a standard #10 coatings draw down bar. The coating was allowed to air dry for 15 minutes and then placed in an oven at a specific temperature for 15 minutes. After removal from the oven the film was allowed to cool at room temperature for 15 minutes. The final thickness of the cured underlayer coatings was determined using a Byk Trigloss Ellipsometer to be approximately 1500 nanometers.

An ethyl lactate puddle test was used to test the degree of cure of the thermally treated coatings. A 0.30 mL drop of ethyl lactate was then placed on the coating using a micropipette. The drop was allowed to sit on the coating for 5 minutes and then the coating was wiped with a dry Kimwipe. The spot on the coatings where the solvent was puddle was visually examined at 10× magnification for any signs of damage. Three levels of cure were distinguishable. No cure is defined as a coating that is completely dissolved by exposure to ethyl lactate for 5 minutes. Partial cure (or cure onset) is defined as a film that maintains its integrity but shows signs of marring, scuffing, or staining due to exposure to the ethyl lactate after cure. Full cure is defined as a coating film that shows no indication of damage after exposure to the ethyl lactate. The minimum temperature where onset cure and full cure were observed in the ethyl lactate puddle test for formulations 7A-E and Comparative 7F are shown in Table 8.

TABLE 8
Minimum Temperature for Onset Cure and Full Cure for Thermally
Curable Underlayer for 193 nm Multiple Layer Resist as a
Function of Catalyst

| Underlayer | | Partial Cure | Full Cure | Difference |
|---|---|---|---|---|
| Formulation | Catalyst | Temp (° C.) | Temp (° C.) | (° C.) |
| Example 7A | Example 1A | 125 | 155 | 30 |
| Example 7B | Example 1B | 160 | 170 | 10 |
| Example 7C | Example 1C | 150 | 165 | 15 |
| Example 7D | Example 1D | 170 | 180 | 10 |
| Example 7E | Example 1E | 125 | 155 | 30 |
| Comparative | Dodecylbenzene | — | 75 | — |
| Example 7F | sulfonic acid | | | |
| Comparative | Amine Salt of | 150 | 190 | 40 |
| Example 7G | Dodecylbenzene | | | |
| | sulfonic acid | | | |

The results reported in Table 8 show the advantage of the latent catalysts of the invention over non-latent catalysts and a typical amine sulfonate latent catalyst. The composition with the non-latent catalyst (dodecylbenzene sulfonic acid) undergoes cure at a low temperature. There is no differentiation between partial or full cure. This is a disadvantage in electronics coating applications where there is often a desire to do a “soft bake” to set the coating prior to crosslinking. The catalysts of the invention also possess a narrow range of activation when compared to a typical amine sufonate latent catalyst as shown by the smaller difference in temperature between the partially cured and fully cured coating.

1. A method of preparing a thermally curable film coating for the manufacture of an integrated circuit by:
blending a latent, heat activatable catalyst that is a thermal acid generator with a polymerizable composition selected from the group consisting of:
a. a cation-polymerizable composition selected from the group consisting of:
i. a substituted or unsubstituted monofunctional epoxy compound selected from the group consisting of: 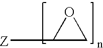
wherein Z is H, a C₁-C₂₀ alkyl, a C₁-C₂₀ alkene, a C₅-C₆ cycloalkyl, or a C₅-C₁₀ aryl and n is 1-3; 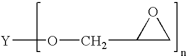
where y is a c₁-C₂₋₀ alkyl, benzyl, vinyl, allyl, a c₅-C₆ cycloalkyl, or a C₅-C₁₀ aryl and n is 1-3;
a glycidyl ester, diglycidylester, or triglycidyl ester: 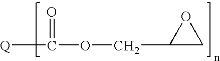
wherein Q is a C₁-C₁₀ alkyl, vinyl, a C₅-C₆ cycloalkyl, C₅-C₁₀ aryl and n is 1-3;
an alicyclic epoxide: 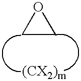
wherein X is H, C₁-C₅ alkyl, C₅-C₁₀ aryl, 1,2-epoxyethyl, acryloyl, alkyloxycarbonyl or alkyloxy wherein the alkyl or alkoxy group is C₁-C₂₀, aryloxycarbonyl or aryloxy wherein the aryl group is C₅-C₁₀ carbons, and m is 3-5;
ii. an epoxy functional group containing polymer selected from the group consisting of polyolefins, polyesters, polyacrylates, polyacrylamides and polymethacrylates, optionally comprising epoxides, diepoxides, polyepoxides, or mixtures thereof
iii. and each of the above optionally comprising a polyol;
b. a crosslinkable composition comprising a hydroxyl-group-containing resin selected from the group consisting of polyalkylene glycols, polyacrylates, polyolefins, and polyesters and 1 wt % to 5 wt % based on solids, a amino resin selected from the group consisting of urea-formaldehyde resins, melamine-formaldehyde resins, benzoquanamine-formaldehyde resins, glycoluril-formaldehyde resins and a mixture thereof;
c. a self-condensing resin selected from the group consisting of hydrogensilsesquioxane; methylsilsesquioxane; polyorganosilicon; and organohydridosiloxane resins having one of the four following formulae:
(HSiO_{1.5})ₙ(RSiO_{1.5})ₘ Formula 1
(H_{0.4-1.0}SiO_{1.5-1.8})ₙ(R_{0.4-1.0}SiO_{1.5-1.8})ₘ Formula 2
(H_{0-1.0}SiO_{1.5-2.0})ₙ(RSiO_{1.5})ₘ Formula 3
wherein the sum of n and m is from 8 to 5000 and m is selected such that the R containing organic moiety is present at at least 40 Mole percent (Mol %);
(HSiO_{1.5})ₓ(RSiO_{1.5})_{y}(SiO₂)_{z} Formula 4
wherein x+y+z is from 8 to 5000 and y is selected such that the R containing organic moiety is present at at least 40 mole percent (Mol %); and R is substituted and unsubstituted linear and branched alkyl, cycloalkyl, aryl, wherein alkyl is C₁-C₄ and aryl is C₅-C₁₀ and mixtures thereof; and
d. a co-condensing resin comprising an alkoxysilyl resin wherein alkoxy is C₁-C₄ with a hydroxyl-group-containing resin polyalkylene glycols, polyacrylates, polyolefins, and polyesters;
wherein the thermal acid generator is in an amount 0.1 wt %-5 wt % based on the solids content of the polymerizable composition and is selected from the group consisting of a N-benzylanilinium salt of a strong acid of Formula I 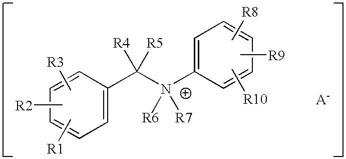
and a N-benzylpyridinium salt of Formula II 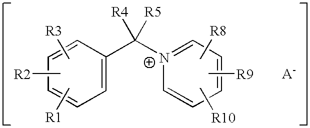
wherein R1, R2, R3, R8, R9, and R10 are independently hydrogen, halogen, alkyl, alkoxy, nitro, amino, alkylamino, cyano, alkoxycarbonyl, or carbamoyl; R4 and R5 are independently hydrogen, alkyl or halogen; R6 and R7 are independently hydrogen or a alkyl, wherein the alkyl is C₁-C₃ and alkoxy is C₁-C₁₂;
and wherein A is selected from the group consisting of:
i. an aromatic sulfonate: 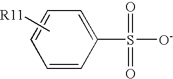
wherein R11 is alkyl, perfluoroalkyl, cyano, dialkylamino, alkoxycarbonyl or carbamoyl, wherein the alkyl or alkoxy is C₁-C₁₂;
ii. an alkylated naphthalene sulfonate: 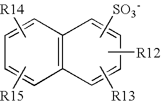
wherein R12, R13, R14 and R15 are independently hydrogen, C₁-C₁₂ alkyl or perfluoroalkyl with C₁-C₈ alkyl;
iii. an alkylated naphthalene disulfonate: 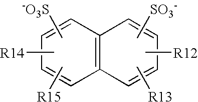
wherein R12 through R15 are as defined above;
iv. a fluorosubstituted C₁-C₁₂ alkyl sulfonate;
v. a sulfonamide: 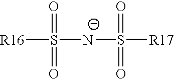
wherein R16 and R17 are independently aryl, C₁-C₁₂ alkyl, fluorosubstituted aryl, or fluorosubstituted C₁-C₁₂ alkyl; and
vi. a methide: 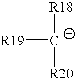
wherein R18, R19, and R20 are independently H or perfluoroalkylsulfonyl, and alkyl is C₁-C₁₂;
Optionally blending into the polymerizable composition optionally 0.1 wt %-5 wt % based on solids, a photobase generator, wherein the photobase generator is a neutral compound which produce an amine base upon exposure to radiation;
dissolving the blended composition in a solvent selected from the group consisting of methanol, ethyl lactate, 2-heptanone, propylene glycol methyl ether acetate and polyethylene glycol monomethyl ether;
applying the solution to a substrate by spin coating, dip coating or spray coating; and
heating the coated substrate to a temperature in the range of 90° C. to 200° C. to form a polymerized film coating.

2. A method of preparing a thermally curable film coating for the manufacture of an integrated circuit according to claim 1 wherein the thermal acid generator is selected from the group consisting of a benzylanilinium salt of a strong acid of Formula I.

3. A method of preparing a thermally curable film coating for the manufacture of an integrated circuit according to claim 1 wherein the thermal acid generator is selected from the group consisting of a benzylpyridnium salt of a strong acid of Formula II.

4. A method of preparing a thermally curable film coating for the manufacture of an integrated circuit according to claim 2 or 3 wherein A is a fluorosubstituted C₁-C₁₂ alkyl sulfonate.

5. A method of preparing a thermally curable film coating for the manufacture of an integrated circuit according to claim 2 or 3 wherein A is trifluoromethane sulfonate.

6. A method of preparing a thermally curable film coating for the manufacture of an integrated circuit according to claim 2 or 3 wherein A is nonafluorobutyl sulfonate.

7. A method of preparing a thermally curable film coating for the manufacture of an integrated circuit according to claim 2 or 3 wherein for the N-benzylanilinium or N-benzylpyridinium cation, R5 is hydrogen, R6 and R7 are methyl, R1-R3 and R8-R10 is selected from the group consisting of hydrogen, methyl and methoxy.

8. A method of preparing a thermally curable film coating for the manufacture of an integrated circuit according to claim 4 wherein for the N-benzylanilinium or N-benzylpyridinium cation, R5 is hydrogen, R6 and R7 are methyl, R1-R3 and R8-R10 is selected from the group consisting of hydrogen, methyl and methoxy.

9. A method of preparing a thermally curable film coating for the manufacture of an integrated circuit according to claim 5 wherein for the N-benzylanilinium or N-benzylpyridinium cation, R5 is hydrogen, R6 and R7 are methyl, R1-R3 and R8-R10 is selected from the group consisting of hydrogen, methyl and methoxy.

10. A method of preparing a thermally curable film coating for the manufacture of an integrated circuit according to claim 6 wherein for the N-benzylanilinium or N-benzylpyridinium cation, R5 is hydrogen, R6 and R7 are methyl, R1-R3 and R8-R10 is selected from the group consisting of hydrogen, methyl and methoxy.

11. A method of preparing a thermally curable film coating for the manufacture of an integrated circuit according to claim 2 or 3 to prepare an underlayer wherein the polymerizable composition comprises a cation-polymerizable monomeric epoxy selected from the group consisting of 1,2-epoxybutane, 1,2-epoxyoctane, 1,2-epoxydodecane, cyclohexyl epoxide, 1,2-epoxycyclohexane, 1,2-epoxy-2-methylpropane, 1,2-epoxy-3-phenoxypropane, 1,2-epoxy-5-hexene, 2,3-epoxy-2-methylbutane, 3,4-epoxy-1-butene, 3,4-epoxycyclohexyloxirane, 3′,4′-epoxycyclohexylmethyl 3,4-epoxycyclohexanecarboxylate, 1,4-dihydro-1,4-epoxynaphthalene, 2-vinyloxirane and diglycidyl ether of bisphenol A, further comprising a polyol.

12. A method of preparing a thermally curable film coating for the manufacture of an integrated circuit according to claim 2 or 3 to prepare an underlayer wherein the polymerizable composition is an alicyclic epoxy selected from the group consisting of 3,4-epoxycyclohexyloxirane, 3′4′-epoxycyclohexylmethyl 3,4-epoxycyclohexancarboxylate, 1,2,5,6-diepoxy-4,7-methano-perhydroindene, 1,6-hexanedioxybis(3,4-epoxycyclohexane, and 1,2-ethylenedioxy-bis(3,4-epoxycyclohexylmethane); and 3,4-epoxycyclohexyloxirane.

13. A method of preparing a thermally curable film coating for the manufacture of an integrated circuit according to claim 12 wherein the the polymerizable composition is an alicyclic epoxy further comprising a polyol.

14. A method of preparing a thermally curable film coating for the manufacture of an integrated circuit according to claim 12 wherein the thermal acid generator is selected from the group consisting of a N-benzylanilinium salt and N-benzylpyridinium salt of fluorosubstituted C₁-C₁₂ alkyl sulfonate.

15. A method of preparing a thermally curable film coating for the manufacture of an integrated circuit according to claim 13 wherein the thermal acid generator is selected from the group consisting of a N-benzylanilinium salt and N-benzylpyridinium salt of fluorosubstituted C₁-C₁₂ alkyl sulfonate.

16. A method of preparing a thermally curable film coating for the manufacture of an integrated circuit according to claim 12 wherein the thermal acid generator is selected from the group consisting of a N-benzylanilinium salt and N-benzylpyridinium salt of trifluoromethane sulfonate.

17. A method of preparing a thermally curable film coating for the manufacture of an integrated circuit according to claim 13 wherein the thermal acid generator is selected from the group consisting of a N-benzylanilinium salt and N-benzylpyridinium salt of trifluoromethane sulfonate.

18. A method of preparing a thermally curable film coating for the manufacture of an integrated circuit according to claim 12 wherein the thermal acid generator is selected from the group consisting of a N-benzylanilinium salt and N-benzylpyridinium salt of nonafluorobutylsulfonate.

19. A method of preparing a thermally curable film coating for the manufacture of an integrated circuit according to claim 13 wherein the thermal acid generator is selected from the group consisting of a N-benzylanilinium salt and N-benzylpyridinium salt of nonafluorobutylsulfonate.

20. A method of preparing a thermally curable film coating for the manufacture of an integrated circuit according to claim 2 or 3 to prepare antireflective coatings (ARCs) or bottom layer antireflective coatings (BARCS) wherein the crosslinkable resin composition is a hydroxyl containing resin, a polyhydroxy styrene: 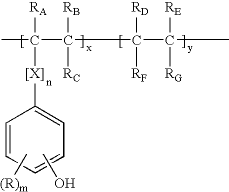
wherein R is hydrogen, halogen, nitro, C₁-C₄ alkyl, C₁-C₄ alkoxy, or C₁-C₄ alkylester; m=1-4, R_{A} to R_{G} are independently hydrogen, halogen, C₁-C₄ alkyl, alicyclic, C₁-C₄ alkoxy, C₁-C₄ ester, —CO₂ (alkyl)OH, —CO₂ (alkyl)COCH₂ COCH₃, or where R_{F} and R_{G} are combined to form a saturated ring or anhydride; T is CO₂, O or SO₂, n=0 or 1, with a weight average MW of the polymer is in the range of 1500 to about 50,000.

21. A method of preparing a thermally curable film coating for the manufacture of an integrated circuit according to claim 20, to prepare an underlayer, wherein the hydroxyl containing resin is selected from the group consisting of poly(hydroxystyrene), poly(hydroxystyrene)-co-(methyl methacrylate), poly(hydroxystyrene)-co-(methyl methacrylate), or a mixture thereof.

22. A method of preparing a thermally curable film coating for the manufacture of an integrated circuit according to claim 21 wherein the thermal acid generator is selected from the group consisting of a N-benzylanilinium salt and N-benzylpyridinium salt of fluorosubstituted C₁-C₁₂ alkyl sulfonate.

23. A method of preparing a thermally curable film coating for the manufacture of an integrated circuit according to claim 20 wherein the thermal acid generator is selected from the group consisting of a N-benzylanilinium salt and N-benzylpyridinium salt of trifluoromethane sulfonate.

24. A method of preparing a thermally curable film coating for the manufacture of an integrated circuit according to claim 21 wherein the thermal acid generator is selected from the group consisting of a N-benzylanilinium salt and N-benzylpyridinium salt of trifluoromethane sulfonate.

25. A method of preparing a thermally curable film coating for the manufacture of an integrated circuit according to claim 20 wherein the thermal acid generator is selected from the group consisting of a N-benzylanilinium salt and N-benzylpyridinium salt of nonafluorobutylsulfonate.

26. A method of preparing a thermally curable film coating for the manufacture of an integrated circuit according to claim 21 wherein the thermal acid generator is selected from the group consisting of a N-benzylanilinium salt and N-benzylpyridinium salt of nonafluorobutylsulfonate.

27. A method of preparing a thermally curable film coating for the manufacture of an integrated circuit according to claim 2 or 3, to prepare positive photoresists, underlayers for multiple layer resists, or antireflective coatings, wherein the crosslinkable resin is a hydroxy containing polyacrylate resin containing a monomer selected from the group consisting of hydroxymethyl acrylate or methacrylate; 2-hydroxyethyl acrylate or methacrylate; 3-hydroxypropyl acrylate or methacrylate; 4-hydroxybutyl acrylate or methacrylate; 5-hydroxypentyl acrylate or methacrylate; and 6-hydroxyhexyl acrylate or methacrylate, 2-hydroxy-2-methylethyl acrylate or methacrylate; 3-hydroxy-3-methypropyl acrylate; 4-hydroxy-4-methylbutyl acrylate or methacrylate; and 5-hydroxy-5-methyl propyl acrylate or methacrylate.

28. A method of preparing a thermally curable film coating for the manufacture of an integrated circuit according to claim 27 wherein the hydroxy containing polyacrylate resin is selected from the group consisting of 2-hydroxyethyl acrylate and 2-hydroxyethyl methacrylate.

29. A method of preparing a thermally curable film coating for the manufacture of an integrated circuit according to claim 28 wherein the hydroxy containing polyacrylate resin further comprises an unsaturated monomer selected from the group consisting of styrene, a substituted styrene, vinyl halide, vinyl ester, vinyl ether, an aliphatic acrylate or methacrylate, a cycloaliphatic acrylate or methacrylate and a mixture thereof.

30. A method of preparing a thermally curable film coating for the manufacture of an integrated circuit according to claim 29 wherein the vinyl halide is vinyl chloride.

31. A method of preparing a thermally curable film coating for the manufacture of an integrated circuit according to claim 29 wherein the vinyl ester is vinyl acetate.

32. A method of preparing a thermally curable film coating for the manufacture of an integrated circuit according to claim 29 wherein the vinyl ether is methyl vinyl ether.

33. A method of preparing a thermally curable film coating for the manufacture of an integrated circuit according to claim 29 wherein the acrylate or methacrylate is methyl acrylate, ethyl acrylate, methyl methacrylate or ethyl methacrylate.

34. A method of preparing a thermally curable film coating for the manufacture of an integrated circuit according to claim 29 wherein the cycloaliphatic acrylate or methacrylate is cyclohexyl acrylate or methacrylate, 4-tert-butylcyclohexyl acrylate or methacrylate, isobornyl acrylate or methacrylate; adamantyl acrylate or methacrylate, 2-(dicyclopentenyloxy)ethyl acrylate or methacrylate.

35. A method of preparing a thermally curable film coating for the manufacture of an integrated circuit according to claim 27 wherein the thermal acid generator is selected from the group consisting of a N-benzylanilinium salt and N-benzylpyridinium salt of fluorosubstituted C₁-C₁₂ alkyl sulfonate.

36. A method of preparing a thermally curable film coating for the manufacture of an integrated circuit according to claim 28 wherein the thermal acid generator is selected from the group consisting of a N-benzylanilinium salt and N-benzylpyridinium salt of fluorosubstituted C₁-C₁₂ alkyl sulfonate.

37. A method of preparing a thermally curable film coating for the manufacture of an integrated circuit according to claim 29 wherein the thermal acid generator is selected from the group consisting of a N-benzylanilinium salt and N-benzylpyridinium salt of fluorosubstituted C₁-C₁₂ alkyl sulfonate.

38. A method of preparing a thermally curable film coating for the manufacture of an integrated circuit according to claim 30 wherein the thermal acid generator is selected from the group consisting of a N-benzylanilinium salt and N-benzylpyridinium salt of fluorosubstituted C₁-C₁₂ alkyl sulfonate.

39. A method of preparing a thermally curable film coating for the manufacture of an integrated circuit according to claim 31 wherein the thermal acid generator is selected from the group consisting of a N-benzylanilinium salt and N-benzylpyridinium salt of fluorosubstituted C₁-C₁₂ alkyl sulfonate.

40. A method of preparing a thermally curable film coating for the manufacture of an integrated circuit according to claim 32 wherein the thermal acid generator is selected from the group consisting of a N-benzylanilinium salt and N-benzylpyridinium salt of fluorosubstituted C₁-C₁₂ alkyl sulfonate.

41. A method of preparing a thermally curable film coating for the manufacture of an integrated circuit according to claim 33 wherein the thermal acid generator is selected from the group consisting of a N-benzylanilinium salt and N-benzylpyridinium salt of fluorosubstituted C₁-C₁₂ alkyl sulfonate.

42. A method of preparing a thermally curable film coating for the manufacture of an integrated circuit according to claim 34 wherein the thermal acid generator is selected from the group consisting of a N-benzylanilinium salt and N-benzylpyridinium salt of fluorosubstituted C₁-C₁₂ alkyl sulfonate.

43. A method of preparing a thermally curable film coating for the manufacture of an integrated circuit according to claim 27 wherein the thermal acid generator is selected from the group consisting of a N-benzylanilinium salt and N-benzylpyridinium salt of trifluoromethane sulfonate.

44. A method of preparing a thermally curable film coating for the manufacture of an integrated circuit according to claim 28 wherein the thermal acid generator is selected from the group consisting of a N-benzylanilinium salt and N-benzylpyridinium salt of trifluoromethane sulfonate.

45. A method of preparing a thermally curable film coating for the manufacture of an integrated circuit according to claim 29 wherein the thermal acid generator is selected from the group consisting of a N-benzylanilinium salt and N-benzylpyridinium salt of trifluoromethane sulfonate.

46. A method of preparing a thermally curable film coating for the manufacture of an integrated circuit according to claim 30 wherein the thermal acid generator is selected from the group consisting of a N-benzylanilinium salt and N-benzylpyridinium salt of trifluoromethane sulfonate.

47. A method of preparing a thermally curable film coating for the manufacture of an integrated circuit according to claim 31 wherein the thermal acid generator is selected from the group consisting of a N-benzylanilinium salt and N-benzylpyridinium salt of trifluoromethane sulfonate.

48. A method of preparing a thermally curable film coating for the manufacture of an integrated circuit according to claim 32 wherein the thermal acid generator is selected from the group consisting of a N-benzylanilinium salt and N-benzylpyridinium salt of trifluoromethane sulfonate.

49. A method of preparing a thermally curable film coating for the manufacture of an integrated circuit according to claim 33 wherein the thermal acid generator is selected from the group consisting of a N-benzylanilinium salt and N-benzylpyridinium salt of trifluoromethane sulfonate.

50. A method of preparing a thermally curable film coating for the manufacture of an integrated circuit according to claim 34 wherein the thermal acid generator is selected from the group consisting of a N-benzylanilinium salt and N-benzylpyridinium salt of trifluoromethane sulfonate.

51. A method of preparing a thermally curable film coating for the manufacture of an integrated circuit according to claim 27 wherein the thermal acid generator is selected from the group consisting of a N-benzylanilinium salt and N-benzylpyridinium salt of nonafluorobutylsulfonate.

52. A method of preparing a thermally curable film coating for the manufacture of an integrated circuit according to claim 28 wherein the thermal acid generator is selected from the group consisting of a N-benzylanilinium salt and N-benzylpyridinium salt of nonafluorobutylsulfonate.

53. A method of preparing a thermally curable film coating for the manufacture of an integrated circuit according to claim 29 wherein the thermal acid generator is selected from the group consisting of a N-benzylanilinium salt and N-benzylpyridinium salt of nonafluorobutylsulfonate.

54. A method of preparing a thermally curable film coating for the manufacture of an integrated circuit according to claim 30 wherein the thermal acid generator is selected from the group consisting of a N-benzylanilinium salt and N-benzylpyridinium salt of nonafluorobutylsulfonate.

55. A method of preparing a thermally curable film coating for the manufacture of an integrated circuit according to claim 31 wherein the thermal acid generator is selected from the group consisting of a N-benzylanilinium salt and N-benzylpyridinium salt of nonafluorobutylsulfonate.

56. A method of preparing a thermally curable film coating for the manufacture of an integrated circuit according to claim 32 wherein the thermal acid generator is selected from the group consisting of a N-benzylanilinium salt and N-benzylpyridinium salt of nonafluorobutylsulfonate.

57. A method of preparing a thermally curable film coating for the manufacture of an integrated circuit according to claim 33 wherein the thermal acid generator is selected from the group consisting of a N-benzylanilinium salt and N-benzylpyridinium salt of nonafluorobutylsulfonate.

58. A method of preparing a thermally curable film coating for the manufacture of an integrated circuit according to claim 34 wherein the thermal acid generator is selected from the group consisting of a N-benzylanilinium salt and N-benzylpyridinium salt of nonafluorobutylsulfonate.

59. A method of preparing a thermally curable film coating for the manufacture of an integrated circuit according to claim 2 or 3 to provide a dielectric layer, photoresist layer, or hard mask etch stop wherein the film forming composition is a self-condensing organosilicone resin selected from the group consisting of completely or partially condensed hydrogensilsesquioxane; methylsilsesquioxane; polyorganosilicone; and organohydridosiloxane resins.

60. A method of preparing a thermally curable film coating for the manufacture of an integrated circuit according to claim 59 wherein the film forming composition is a self-condensing organosilicone resin selected from the group consisting of partially condensed hydrogensilsesquioxane; methylsilsesquioxane; polyorganosilicone; and organohydridosiloxane resins.

61. A method of preparing a thermally curable film coating for the manufacture of an integrated circuit according to claim 59 wherein R of (RSiO) is selected from the group consisting of methyl, phenyl, butyl, benzyl, chloromethyl and mixtures thereof.

62. A method of preparing a thermally curable film coating for the manufacture of an integrated circuit according to claim 60, wherein the organosilicone resin comprising 5 to 50 Mol % of (PhSiO_{(3-x)/2}(OH)ₓ) units and 50 to 95 Mol % (HSiO_{(3-x)/2}(OH)ₓ), where Ph is a phenyl group, x has a value of 0, 1 or 2.

63. A method of preparing a thermally curable film coating for the manufacture of an integrated circuit according to claim 59 wherein the thermal acid generator is selected from the group consisting of a N-benzylanilinium salt and N-benzylpyridinium salt of fluorosubstituted C₁-C₁₂ alkyl sulfonate.

64. A method of preparing a thermally curable film coating for the manufacture of an integrated circuit according to claim 60 wherein the thermal acid generator is selected from the group consisting of a N-benzylanilinium salt and N-benzylpyridinium salt of fluorosubstituted C₁-C₁₂ alkyl sulfonate.

65. A method of preparing a thermally curable film coating for the manufacture of an integrated circuit according to claim 61 wherein the thermal acid generator is selected from the group consisting of a N-benzylanilinium salt and N-benzylpyridinium salt of fluorosubstituted C₁-C₁₂ alkyl sulfonate.

66. A method of preparing a thermally curable film coating for the manufacture of an integrated circuit according to claim 62 wherein the thermal acid generator is selected from the group consisting of a N-benzylanilinium salt and N-benzylpyridinium salt of fluorosubstituted C₁-C₁₂ alkyl sulfonate.

67. A method of preparing a thermally curable film coating for the manufacture of an integrated circuit according to claim 59 wherein the thermal acid generator is selected from the group consisting of a N-benzylanilinium salt and N-benzylpyridinium salt of trifluoromethane sulfonate.

68. A method of preparing a thermally curable film coating for the manufacture of an integrated circuit according to claim 60 wherein the thermal acid generator is selected from the group consisting of a N-benzylanilinium salt and N-benzylpyridinium salt of trifluoromethane sulfonate.

69. A method of preparing a thermally curable film coating for the manufacture of an integrated circuit according to claim 61 wherein the thermal acid generator is selected from the group consisting of a N-benzylanilinium salt and N-benzylpyridinium salt of trifluoromethane sulfonate.

70. A method of preparing a thermally curable film coating for the manufacture of an integrated circuit according to claim 62 wherein the thermal acid generator is selected from the group consisting of a N-benzylanilinium salt and N-benzylpyridinium salt of trifluoromethane sulfonate.

71. A method of preparing a thermally curable film coating for the manufacture of an integrated circuit according to claim 59 wherein the thermal acid generator is selected from the group consisting of a N-benzylanilinium salt and N-benzylpyridinium salt of nonafluorobutylsulfonate.

72. A method of preparing a thermally curable film coating for the manufacture of an integrated circuit according to claim 60 wherein the thermal acid generator is selected from the group consisting of a N-benzylanilinium salt and N-benzylpyridinium salt of nonafluorobutylsulfonate.

73. A method of preparing a thermally curable film coating for the manufacture of an integrated circuit according to claim 61 wherein the thermal acid generator is selected from the group consisting of a N-benzylanilinium salt and N-benzylpyridinium salt of nonafluorobutylsulfonate.

74. A method of preparing a thermally curable film coating for the manufacture of an integrated circuit according to claim 62 wherein the thermal acid generator is selected from the group consisting of a N-benzylanilinium salt and N-benzylpyridinium salt of nonafluorobutylsulfonate.

75. A method of preparing a thermally curable film coating for the manufacture of an integrated circuit according to claim 2 or 3 to provide a antireflective coating, dielectric layer, photoresist layer, or hard mask etch stop wherein the film forming composition is a co-condensing resin selected from the group consisting of (RO)₃Si(A)Si(OR)₃ wherein A is a polymer or oligomer —(SiB₂O)ₙ—, —(CB₂)ₙ—, or —(SiY₂)ₙ—, and R is methyl, ethyl, n-propyl or isopropyl and B is H, methyl, t-butyl, phenyl, 1,2-epoxyethyl, or 2,3-epoxypropyl.

76. A method of preparing a thermally curable film coating for the manufacture of an integrated circuit according to claim 75 wherein the polymerizabel composition further comprises a hydroxyl group containing resin selected from the group consisting of hydroxyl containing polyesters, polyacrylates and polyoelfins.

77. A method of preparing a thermally curable film coating for the manufacture of an integrated circuit according to claim 75 wherein the thermal acid generator is selected from the group consisting of a N-benzylanilinium salt and N-benzylpyridinium salt of fluorosubstituted C₁-C₁₂ alkyl sulfonate.

78. A method of preparing a thermally curable film coating for the manufacture of an integrated circuit according to claim 76 wherein the thermal acid generator is selected from the group consisting of a N-benzylanilinium salt and N-benzylpyridinium salt of fluorosubstituted C₁-C₁₂ alkyl sulfonate.

79. A method of preparing a thermally curable film coating for the manufacture of an integrated circuit according to claim 75 wherein the thermal acid generator is selected from the group consisting of a N-benzylanilinium salt and N-benzylpyridinium salt of trifluoromethane sulfonate.

80. A method of preparing a thermally curable film coating for the manufacture of an integrated circuit according to claim 76 wherein the thermal acid generator is selected from the group consisting of a N-benzylanilinium salt and N-benzylpyridinium salt of trifluoromethane sulfonate.

81. A method of preparing a thermally curable film coating for the manufacture of an integrated circuit according to claim 75 wherein the thermal acid generator is selected from the group consisting of a N-benzylanilinium salt and N-benzylpyridinium salt of nonafluorobutylsulfonate.

82. A method of preparing a thermally curable film coating for the manufacture of an integrated circuit according to claim 76 wherein the thermal acid generator is selected from the group consisting of a N-benzylanilinium salt and N-benzylpyridinium salt of nonafluorobutylsulfonate.

83. A method of preparing a thermally curable film coating for the manufacture of an integrated circuit according to claim 2 or 3 to provide underlayers for multiple layer resists, or antireflective coatings, wherein the film forming composition is a crosslinkable hydroxy containing polyester resin derived from the polymerization of a diol, triol or tetraol with a diacid or triacid or an diester, triester or carboxylic acid anhydride or a mixture thereof.

84. A method of preparing a thermally curable film coating for the manufacture of an integrated circuit according to claim 83 wherein the diol, triol or tetraol is selected from the group consisting of ethylene glycol, propylene glycol, pentanediol, hexanediol, glycerol 1,4-cyclohexanediethanol, hydroquinone, phenylenedimethanol, resorcinol, naphthalenediol, anthracene-1,10-diol, 1,3,5-tris(2-hydroxyehtyl cyanuric acid), trimethylol propane, pentarythiol, and a mixture thereof and the diacid or triacid, is selected from the group consisting of oxalic, malonic, succinic, adipic, phthalic, iso-phthalic, 5-nitroisophthalic, nitroterephthalic, naphthalene dicarboxylic, 1,2,3-benzenetricarboxylic, trimellitic acid and the diester or triester or carboxylic acid anhydride of the diacid or triacid.

85. A method of preparing a thermally curable film coating for the manufacture of an integrated circuit according to claim 83 wherein the thermal acid generator is selected from the group consisting of a N-benzylanilinium salt and N-benzylpyridinium salt of fluorosubstituted C₁-C₁₂ alkyl sulfonate.

86. A method of preparing a thermally curable film coating for the manufacture of an integrated circuit according to claim 84 wherein the thermal acid generator is selected from the group consisting of a N-benzylanilinium salt and N-benzylpyridinium salt of fluorosubstituted C₁-C₁₂ alkyl sulfonate.

87. A method of preparing a thermally curable film coating for the manufacture of an integrated circuit according to claim 83 wherein the thermal acid generator is selected from the group consisting of a N-benzylanilinium salt and N-benzylpyridinium salt of trifluoromethane sulfonate.

88. A method of preparing a thermally curable film coating for the manufacture of an integrated circuit according to claim 84 wherein the thermal acid generator is selected from the group consisting of a N-benzylanilinium salt and N-benzylpyridinium salt of trifluoromethane sulfonate.

89. A method of preparing a thermally curable film coating for the manufacture of an integrated circuit according to claim 83 wherein the thermal acid generator is selected from the group consisting of a N-benzylanilinium salt and N-benzylpyridinium salt of nonafluorobutylsulfonate.

90. A method of preparing a thermally curable film coating for the manufacture of an integrated circuit according to claim 84 wherein the thermal acid generator is selected from the group consisting of a N-benzylanilinium salt and N-benzylpyridinium salt of nonafluorobutylsulfonate.

91. A thermally curable film coating composition for the manufacture of an integrated circuit comprising a blend of a latent, heat activatable catalyst that is a thermal acid generator with a polymerizable composition selected from the group consisting of:
a. a crosslinkable composition comprising a hydroxyl-group-containing resin selected from the group consisting of polyalkylene glycols, polyacrylates, polyolefins, and polyesters and 1 wt % to 5 wt % based on solids, a amino resin selected from the group consisting of urea-formaldehyde resins, melamine-formaldehyde resins, benzoquanamine-formaldehyde resins, glycoluril-formaldehyde resins and a mixture thereof;
b. a self-condensing resin selected from the group consisting of hydrogensilsesquioxane; methylsilsesquioxane; polyorganosilicon; and organohydridosiloxane resins having one of the four following formulae:
(HSiO_{1.5})ₙ(RSiO_{1.5})ₘ Formula 1
(H_{0.4-1.0}SiO_{1.5-1.8})ₙ(R_{0.4-1.0}SiO_{1.5-1.8})ₘ Formula 2
(H_{0-1.0}SiO_{1.5-2.0})₁(RSiO_{1.5})ₘ Formula 3
wherein the sum of n and m is from 8 to 5000 and m is selected such that the R containing organic moiety is present at at least 40 Mole percent (Mol %);
(HSiO_{1.5})ₓ(RSiO_{1.5})_{y}(SiO₂)_{z} Formula 4
wherein x+y+z is from 8 to 5000 and y is selected such that the R contianing organic moiety is present at at least 40 mole percent (Mol %); and R is substituted and unsubstituted linear and branched alkyl, cycloalkyl, aryl, wherein alkyl is C₁-C₄ and aryl is C₅-C₁₀ and mixtures thereof; and
c. a co-condensing resin comprising an alkoxysilyl resin wherein alkoxy is C₁-C₄ with a hydroxyl-group-containing resin polyalkylene glycols, polyacrylates, polyolefins, and polyesters;
wherein the thermal acid generator is in an amount 0.1 wt %-5 wt % based on the solids content of the polymerizable composition and is selected from the group consisting of a N-benzylanilinium salt of a strong acid of Formula I 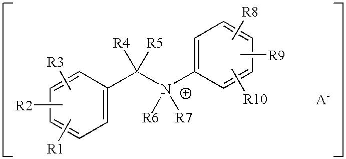
and a N-benzylpyridinium salt of Formula II 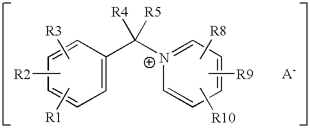
wherein R1, R2, R3, R8, R9, and R10 are independently hydrogen, halogen, alkyl, alkoxy, nitro, amino, alkylamino, cyano, alkoxycarbonyl, or carbamoyl; R4 and R5 are independently hydrogen, alkyl or halogen; R6 and R7 are independently hydrogen or a alkyl, wherein the alkyl is C₁-C₃ and alkoxy is C₁-C₁₂;
and wherein A is selected from the group consisting of:
i. an aromatic sulfonate: 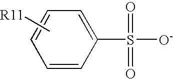
wherein R11 is alkyl, perfluoroalkyl, cyano, dialkylamino, alkoxycarbonyl or carbamoyl, wherein the alkyl or alkoxy is C₁-C₁₂;
ii. an alkylated naphthalene sulfonate: 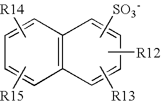
wherein R12, R13, R14 and R15 are independently hydrogen, C₁-C₁₂ alkyl or perfluoroalkyl with C₁-C₈ alkyl;
iii. an alkylated naphthalene disulfonate: 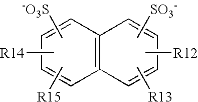
wherein R12 through R15 are as defined above;
iv. a fluorosubstituted C₁-C₁₂ alkyl sulfonate;
v. a sulfonamide: 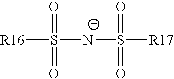
wherein R16 and R17 are independently aryl, C₁-C₁₂ alkyl, fluorosubstituted aryl, or fluorosubstituted C₁-C₁₂ alkyl; and
vi. a methide: 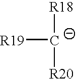
wherein R18, R19, and R20 are independently H or perfluoroalkylsulfonyl, and alkyl is C₁-C₁₂;
Optionally blending into the polymerizable composition optionally 0.1 wt %-5 wt % based on solids, a photobase generator.

92. A thermally curable film coating composition for the manufacture of an integrated circuit comprising a blend of a latent, heat activatable catalyst that is a thermal acid generator with a polymerizable composition of claim 91, further comprising a solvent selected from the group consisting of methanol, ethyl lactate, 2-heptanone, propylene glycol methyl ether acetate and propylene glycol monomethyl ether.

93. A thermally curable film coating composition for the manufacture of an integrated circuit comprising a blend of a latent, heat activatable catalyst that is a thermal acid generator with a polymerizable composition of claim 91, wherein the thermal acid generator is selected from the group consisting of a benzylanilinium salt of a strong acid of Formula I.

94. A thermally curable film coating composition for the manufacture of an integrated circuit comprising a blend of a latent, heat activatable catalyst that is a thermal acid generator with a polymerizable composition of claim 91, wherein the thermal acid generator is selected from the group consisting of a benzylpyridnium salt of a strong acid of Formula II.

95. A thermally curable film coating composition for the manufacture of an integrated circuit comprising a blend of a latent, heat activatable catalyst that is a thermal acid generator with a polymerizable composition of claim 93 or 94 wherein A is a fluorosubstituted C₁-C₁₂ alkyl sulfonate.

96. A thermally curable film coating composition for the manufacture of an integrated circuit comprising a blend of a latent, heat activatable catalyst that is a thermal acid generator with a polymerizable composition of claim 93 or 94 wherein A is trifluoromethane sulfonate.

97. A thermally curable film coating composition for the manufacture of an integrated circuit comprising a blend of a latent, heat activatable catalyst that is a thermal acid generator with a polymerizable composition of claim 93 or 94 wherein A is nonafluorobutyl sulfonate.

98. A thermally curable film coating composition for the manufacture of an integrated circuit comprising a blend of a latent, heat activatable catalyst that is a thermal acid generator with a polymerizable composition of claim 93 or 94 wherein for the N-benzylanilinium or N-benzylpyridinium cation, R5 is hydrogen, R6 and R7 are methyl, R1-R3 and R8-R10 is selected from the group consisting of hydrogen, methyl and methoxy.

99. A thermally curable film coating composition for the manufacture of an integrated circuit comprising a blend of a latent, heat activatable catalyst that is a thermal acid generator with a polymerizable composition of claim 95 wherein for the N-benzylanilinium or N-benzylpyridinium cation, R5 is hydrogen, R6 and R7 are methyl, R1-R3 and R8-R10 is selected from the group consisting of hydrogen, methyl and methoxy.

100. A thermally curable film coating composition for the manufacture of an integrated circuit comprising a blend of a latent, heat activatable catalyst that is a thermal acid generator with a polymerizable composition of claim 96, wherein for the N-benzylanilinium or N-benzylpyridinium cation, R5 is hydrogen, R6 and R7 are methyl, R1-R3 and R8-R10 is selected from the group consisting of hydrogen, methyl and methoxy.

101. A thermally curable film coating composition for the manufacture of an integrated circuit comprising a blend of a latent, heat activatable catalyst that is a thermal acid generator with a polymerizable composition of claim 96, wherein for the N-benzylanilinium or N-benzylpyridinium cation, R5 is hydrogen, R6 and R7 are methyl, R1-R3 and R8-R10 is selected from the group consisting of hydrogen, methyl and methoxy.

102. A thermally curable film coating composition for the manufacture of an integrated circuit comprising a blend of a latent, heat activatable catalyst that is a thermal acid generator with a polymerizable composition of claim 93 or 94 to provide antireflective coatings (ARCS) or bottom layer antireflective coatings (BARCS) wherein the crosslinkable resin composition is a hydroxyl containing resin, a polyhydroxy styrene: 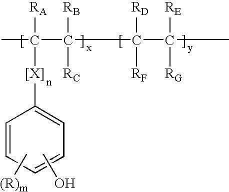
wherein R is hydrogen, halogen, nitro, C₁-C₄ alkyl, C₁-C₄ alkoxy, or C₁-C₄ alkylester; m=1-4, R_{A} to R_{G} are independently hydrogen, halogen, C₁-C₄ alkyl, alicyclic, C₁-C₄ alkoxy, C₁-C₄ ester, —CO₂ (alkyl)OH, —CO₂ (alkyl)COCH₂ COCH₃, or where R_{F} and R_{G} are combined to form a saturated ring or anhydride; T is CO₂, O or SO₂, n=0 or 1, with a weight average MW of the polymer is in the range of 1500 to about 50,000.

103. A thermally curable film coating composition for the manufacture of an integrated circuit comprising a blend of a latent, heat activatable catalyst that is a thermal acid generator with a polymerizable composition of claim 102 to provide antireflective coatings (ARCs) or bottom layer antireflective coatings (BARCS) wherein the hydroxyl containing resin is selected from the group consisting of poly(hydroxystyrene), poly(hydroxystyrene)-co-(methyl methacrylate), poly(hydroxystyrene)-co-(methyl methacrylate), or a mixture thereof.

104. A thermally curable film coating composition for the manufacture of an integrated circuit comprising a blend of a latent, heat activatable catalyst that is a thermal acid generator with a polymerizable composition of claim 103 to provide antireflective coatings (ARCs) or bottom layer antireflective coatings (BARCS) wherein the thermal acid generator is selected from the group consisting of a N-benzylanilinium salt and N-benzylpyridinium salt of fluorosubstituted C₁-C₁₂ alkyl sulfonate.

105. A thermally curable film coating composition for the manufacture of an integrated circuit comprising a blend of a latent, heat activatable catalyst that is a thermal acid generator with a polymerizable composition of claim 102 to provide antireflective coatings (ARCs) or bottom layer antireflective coatings (BARCS) wherein the thermal acid generator is selected from the group consisting of a N-benzylanilinium salt and N-benzylpyridinium salt of trifluoromethane sulfonate.

106. A thermally curable film coating composition for the manufacture of an integrated circuit comprising a blend of a latent, heat activatable catalyst that is a thermal acid generator with a polymerizable composition of claim 103 to provide antireflective coatings (ARCs) or bottom layer antireflective coatings (BARCS) wherein the thermal acid generator is selected from the group consisting of a N-benzylanilinium salt and N-benzylpyridinium salt of trifluoromethane sulfonate.

107. A thermally curable film coating composition for the manufacture of an integrated circuit comprising a blend of a latent, heat activatable catalyst that is a thermal acid generator with a polymerizable composition of claim 102 to provide antireflective coatings (ARCs) or bottom layer antireflective coatings (BARCS) wherein the thermal acid generator is selected from the group consisting of a N-benzylanilinium salt and N-benzylpyridinium salt of nonafluorobutylsulfonate.

108. A thermally curable film coating composition for the manufacture of an integrated circuit comprising a blend of a latent, heat activatable catalyst that is a thermal acid generator with a polymerizable composition of claim 103 to provide antireflective coatings (ARCs) or bottom layer antireflective coatings (BARCS) wherein the thermal acid generator is selected from the group consisting of a N-benzylanilinium salt and N-benzylpyridinium salt of nonafluorobutylsulfonate.

109. A thermally curable film coating composition for the manufacture of an integrated circuit comprising a blend of a latent, heat activatable catalyst that is a thermal acid generator with a polymerizable composition of claim 93 or 94 to provide positive photoresists, underlayers for multiple layer resists, or antireflective coatings, wherein the crosslinkable resin is a hydroxy containing polyacrylate resin containing a monomer selected from the group consisting of hydroxymethyl acrylate or methacrylate; 2-hydroxyethyl acrylate or methacrylate; 3-hydroxypropyl acrylate or methacrylate; 4-hydroxybutyl acrylate or methacrylate; 5-hydroxypentyl acrylate or methacrylate; and 6-hydroxyhexyl acrylate or methacrylate, 2-hydroxy-2-methylethyl acrylate or methacrylate; 3-hydroxy-3-methypropyl acrylate; 4-hydroxy-4-methylbutyl acrylate or methacrylate; and 5-hydroxy-5-methyl propyl acrylate or methacrylate.

110. A thermally curable film coating composition for the manufacture of an integrated circuit comprising a blend of a latent, heat activatable catalyst that is a thermal acid generator with a polymerizable composition of claim 109 to provide positive photoresists, underlayers for multiple layer resists, or antireflective coatings wherein the hydroxy containing polyacrylate resin is selected from the group consisting of 2-hydroxyethyl acrylate and 2-hydroxyethyl methacrylate.

111. A thermally curable film coating composition for the manufacture of an integrated circuit comprising a blend of a latent, heat activatable catalyst that is a thermal acid generator with a polymerizable composition of claim 110 to provide positive photoresists, underlayers for multiple layer resists, or antireflective coatings wherein the hydroxy containing polyacrylate resin further comprises an unsaturated monomer selected from the group consisting of styrene, a substituted styrene, vinyl halide, vinyl ester, vinyl ether, an aliphatic acrylate or methacrylate, a cycloaliphatic acrylate or methacrylate and a mixture thereof.

112. A thermally curable film coating composition for the manufacture of an integrated circuit comprising a blend of a latent, heat activatable catalyst that is a thermal acid generator with a polymerizable composition of claim 111 to provide positive photoresists, underlayers for multiple layer resists, or antireflective coatings wherein the vinyl halide is vinyl chloride.

113. A thermally curable film coating composition for the manufacture of an integrated circuit comprising a blend of a latent, heat activatable catalyst that is a thermal acid-generator with a polymerizable composition of claim 111 to provide positive photoresists, underlayers for multiple layer resists, or antireflective coatings wherein the vinyl ester is vinyl acetate.

114. A thermally curable film coating composition for the manufacture of an integrated circuit comprising a blend of a latent, heat activatable catalyst that is a thermal acid generator with a polymerizable composition of claim 111 to provide positive photoresists, underlayers for multiple layer resists, or antireflective coatings wherein the vinyl ether is methyl vinyl ether.

115. A thermally curable film coating composition for the manufacture of an integrated circuit comprising a blend of a latent, heat activatable catalyst that is a thermal acid generator with a polymerizable composition of claim 111 to provide positive photoresists, underlayers for multiple layer resists, or antireflective coatings wherein the acrylate or methacrylate is methyl acrylate, ethyl acrylate, methyl methacrylate or ethyl methacrylate.

116. A thermally curable film coating composition for the manufacture of an integrated circuit comprising a blend of a latent, heat activatable catalyst that is a thermal acid generator with a polymerizable composition of claim 111 to provide positive photoresists, underlayers for multiple layer resists, or antireflective coatings wherein the cycloaliphatic acrylate or methacrylate is cyclohexyl acrylate or methacrylate, 4-tert-butylcyclohexyl acrylate or methacrylate, isobornyl acrylate or methacrlate; admantyl acrylate or methacrylate, 2-(dicyclopentenyloxy)ethyl acrylate or methacrylate.

117. A thermally curable film coating composition for the manufacture of an integrated circuit comprising a blend of a latent, heat activatable catalyst that is a thermal acid generator with a polymerizable composition of claim 109 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

118. A thermally curable film coating composition for the manufacture of an integrated circuit comprising a blend of a latent, heat activatable catalyst that is a thermal acid generator with a polymerizable composition of claim 110 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

119. A thermally curable film coating composition for the manufacture of an integrated circuit comprising a blend of a latent, heat activatable catalyst that is a thermal acid generator with a polymerizable composition of claim 111 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

120. A thermally curable film coating composition for the manufacture of an integrated circuit comprising a blend of a latent, heat activatable catalyst that is a thermal acid generator with a polymerizable composition of claim 112 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

121. A thermally curable film coating composition for the manufacture of an integrated circuit comprising a blend of a latent, heat activatable catalyst that is a thermal acid generator with a polymerizable composition of claim 113 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

122. A thermally curable film coating composition for the manufacture of an integrated circuit comprising a blend of a latent, heat activatable catalyst that is a thermal acid generator with a polymerizable composition of claim 114 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

123. A thermally curable film coating composition for the manufacture of an integrated circuit comprising a blend of a latent, heat activatable catalyst that is a thermal acid generator with a polymerizable composition of claim 115 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

124. A thermally curable film coating composition for the manufacture of an integrated circuit comprising a blend of a latent, heat activatable catalyst that is a thermal acid generator with a polymerizable composition of claim 116 to provide positive photoresists, underlayers for multiple layer resists, or antireflective coatings wherein the thermal acid generator is selected from the group consisting of a N-benzylanilinium salt and N-benzylpyridinium salt of fluorosubstituted C₁-C₁₂ alkyl sulfonate.

125. A thermally curable film coating composition for the manufacture of an integrated circuit comprising a blend of a latent, heat activatable catalyst that is a thermal acid generator with a polymerizable composition of claim 109 to provide positive photoresists, underlayers for multiple layer resists, or antireflective coatings, wherein the thermal acid generator is selected from the group consisting of a N-benzylanilinium salt and N-benzylpyridinium salt of trifluoromethane sulfonate.

126. A thermally curable film coating composition for the manufacture of an integrated circuit comprising a blend of a latent, heat activatable catalyst that is a thermal acid generator with a polymerizable composition of claim 110 to provide positive photoresists, underlayers for multiple layer resists, or antireflective coatings, wherein the thermal acid generator is selected from the group consisting of a N-benzylanilinium salt and N-benzylpyridinium salt of trifluoromethane sulfonate.

127. A thermally curable film coating composition for the manufacture of an integrated circuit comprising a blend of a latent, heat activatable catalyst that is a thermal acid generator with a polymerizable composition of claim 111 to provide positive photoresists, underlayers for multiple layer resists, or antireflective coatings, wherein the thermal acid generator is selected from the group consisting of a N-benzylanilinium salt and N-benzylpyridinium salt of trifluoromethane sulfonate.

128. A thermally curable film coating composition for the manufacture of an integrated circuit comprising a blend of a latent, heat activatable catalyst that is a thermal acid generator with a polymerizable composition of claim 112 to provide positive photoresists, underlayers for multiple layer resists, or antireflective coatings, wherein the thermal acid generator is selected from the group consisting of a N-benzylanilinium salt and N-benzylpyridinium salt of trifluoromethane sulfonate.

129. A thermally curable film coating composition for the manufacture of an integrated circuit comprising a blend of a latent, heat activatable catalyst that is a thermal acid generator with a polymerizable composition of claim 113 to provide positive photoresists, underlayers for multiple layer resists, or antireflective coatings, wherein the thermal acid generator is selected from the group consisting of a N-benzylanilinium salt and N-benzylpyridinium salt of trifluoromethane sulfonate.

130. A thermally curable film coating composition for the manufacture of an integrated circuit comprising a blend of a latent, heat activatable catalyst that is a thermal acid generator with a polymerizable composition of claim 114 to provide positive photoresists, underlayers for multiple layer resists, or antireflective coatings wherein the thermal acid generator is selected from the group consisting of a N-benzylanilinium salt and N-benzylpyridinium salt of trifluoromethane sulfonate.

131. A thermally curable film coating composition for the manufacture of an integrated circuit comprising a blend of a latent, heat activatable catalyst that is a thermal acid generator with a polymerizable composition of claim 115 to provide positive photoresists, underlayers for multiple layer resists, or antireflective coatings, wherein the thermal acid generator is selected from the group consisting of a N-benzylanilinium salt and N-benzylpyridinium salt of trifluoromethane sulfonate.

132. A thermally curable film coating composition for the manufacture of an integrated circuit comprising a blend of a latent, heat activatable catalyst that is a thermal acid generator with a polymerizable composition of claim 116 to provide positive photoresists, underlayers for multiple layer resists, or antireflective coatings, wherein the thermal acid generator is selected from the group consisting of a N-benzylanilinium salt and N-benzylpyridinium salt of trifluoromethane sulfonate.

133. A thermally curable film coating composition for the manufacture of an integrated circuit comprising a blend of a latent, heat activatable catalyst that is a thermal acid generator with a polymerizable composition of claim 109 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

134. A thermally curable film coating composition for the manufacture of an integrated circuit comprising a blend of a latent, heat activatable catalyst that is a thermal acid generator with a polymerizable composition of claim 110 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

135. A thermally curable film coating composition for the manufacture of an integrated circuit comprising a blend of a latent, heat activatable catalyst that is a thermal acid generator with a polymerizable composition of claim 111 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

136. A thermally curable film coating composition for the manufacture of an integrated circuit comprising a blend of a latent, heat activatable catalyst that is a thermal acid generator with a polymerizable composition of claim 112 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

137. A thermally curable film coating composition for the manufacture of an integrated circuit comprising a blend of a latent, heat activatable catalyst that is a thermal acid generator with a polymerizable composition of claim 113 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

138. A thermally curable film coating composition for the manufacture of an integrated circuit comprising a blend of a latent, heat activatable catalyst that is a thermal acid generator with a polymerizable composition of claim 114 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

139. A thermally curable film coating composition for the manufacture of an integrated circuit comprising a blend of a latent, heat activatable catalyst that is a thermal acid generator with a polymerizable composition of claim 115 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

140. A thermally curable film coating composition for the manufacture of an integrated circuit comprising a blend of a latent, heat activatable catalyst that is a thermal acid generator with a polymerizable composition of claim 116 to provide positive photoresists, underlayers for multiple layer resists, or antireflective coatings, wherein the thermal acid generator is selected from the group consisting of a N-benzylanilinium salt and N-benzylpyridinium salt of nonafluorobutylsulfonate.

141. A thermally curable film coating composition for the manufacture of an integrated circuit comprising a blend of a latent, heat activatable catalyst that is a thermal acid generator with a polymerizable composition of claim 93 or 94 to provide a dielectric layer, photoresist layer, or hard mask etch stop wherein the film forming composition is a self-condensing organosilicone resin selected from the group consisting of completely or partially condensed hydrogensilsesquioxane; methylsilsesquioxane; polyorganosilicone; and organohydridosiloxane resins.

142. A thermally curable film coating composition for the manufacture of an integrated circuit comprising a blend of a latent, heat activatable catalyst that is a thermal acid generator with a polymerizable composition of claim 141 to provide a dielectric layer, photoresist layer, or hard mask etch stop wherein the film forming composition is a self-condensing organosilicone resin selected from the group consisting of partially condensed hydrogensilsesquioxane; methylsilsesquioxane; polyorganosilicone; and organohydridosiloxane resins.

143. A thermally curable film coating composition for the manufacture of an integrated circuit comprising a blend of a latent, heat activatable catalyst that is a thermal acid generator with a polymerizable composition of claim 141 to provide a dielectric layer, photoresist layer, or hard mask etch stop wherein R of (RSiO) is selected from the group consisting of methyl, phenyl, butyl, benzyl, chloromethyl and mixtures thereof.

144. A thermally curable film coating composition for the manufacture of an integrated circuit comprising a blend of a latent, heat activatable catalyst that is a thermal acid generator with a polymerizable composition of claim 142 to provide a dielectric layer, photoresist layer, or hard mask etch stop, wherein the organosilicone resin comprising 5 to 50 Mol % of (PhSiO_{(3-x)/2}(OH)ₓ) units and 50 to 95 Mol % (HSiO_{(3-x)/2}(OH)ₓ), where Ph is a phenyl group, x has a value of 0, 1 or 2.

145. A thermally curable film coating composition for the manufacture of an integrated circuit comprising a blend of a latent, heat activatable catalyst that is a thermal acid generator with a polymerizable composition of claim 141 to provide a dielectric layer, photoresist layer, or hard mask etch stop wherein the thermal acid generator is selected from the group consisting of a N-benzylanilinium salt and N-benzylpyridinium salt of fluorosubstituted C₁-C₁₂ alkyl sulfonate.

146. A thermally curable film coating composition for the manufacture of an integrated circuit comprising a blend of a latent, heat activatable catalyst that is a thermal acid generator with a polymerizable composition of claim 142 to provide a dielectric layer, photoresist layer, or hard mask etch stop wherein the thermal acid generator is selected from the group consisting of a N-benzylanilinium salt and N-benzylpyridinium salt of fluorosubstituted C₁-C₁₂ alkyl sulfonate.

147. A thermally curable film coating composition for the manufacture of an integrated circuit comprising a blend of a latent, heat activatable catalyst that is a thermal acid generator with a polymerizable composition of claim 143 to provide a dielectric layer, photoresist layer, or hard mask etch stop wherein the thermal acid generator is selected from the group consisting of a N-benzylanilinium salt and N-benzylpyridinium salt of fluorosubstituted C₁-C₁₂ alkyl sulfonate.

148. A thermally curable film coating composition for the manufacture of an integrated circuit comprising a blend of a latent, heat activatable catalyst that is a thermal acid generator with a polymerizable composition of claim 144 to provide a dielectric layer, photoresist layer, or hard mask etch stop wherein the thermal acid generator is selected from the group consisting of a N-benzylanilinium salt and N-benzylpyridinium salt of fluorosubstituted C₁-C₁₂ alkyl sulfonate.

149. A thermally curable film coating composition for the manufacture of an integrated circuit comprising a blend of a latent, heat activatable catalyst that is a thermal acid generator with a polymerizable composition of claim 141 to provide a dielectric layer, photoresist layer, or hard mask etch stop wherein the thermal acid generator is selected from the group consisting of a N-benzylanilinium salt and N-benzylpyridinium salt of trifluoromethane sulfonate.

150. A thermally curable film coating composition for the manufacture of an integrated circuit comprising a blend of a latent, heat activatable catalyst that is a thermal acid generator with a polymerizable composition of claim 142 to provide a dielectric layer, photoresist layer, or hard mask etch stop wherein the thermal acid generator is selected from the group consisting of a N-benzylanilinium salt and N-benzylpyridinium salt of trifluoromethane sulfonate.

151. A thermally curable film coating composition for the manufacture of an integrated circuit comprising a blend of a latent, heat activatable catalyst that is a thermal acid generator with a polymerizable composition of claim 143 to provide a dielectric layer, photoresist layer, or hard mask etch stop wherein the thermal acid generator is selected from the group consisting of a N-benzylanilinium salt and N-benzylpyridinium salt of trifluoromethane sulfonate.

152. A thermally curable film coating composition for the manufacture of an integrated circuit comprising a blend of a latent, heat activatable catalyst that is a thermal acid generator with a polymerizable composition of claim 144 to provide a dielectric layer, photoresist layer, or hard mask etch stop wherein the thermal acid generator is selected from the group consisting of a N-benzylanilinium salt and N-benzylpyridinium salt of trifluoromethane sulfonate.

153. A thermally curable film coating composition for the manufacture of an integrated circuit comprising a blend of a latent, heat activatable catalyst that is a thermal acid generator with a polymerizable composition of claim 141 to provide a dielectric layer, photoresist layer, or hard mask etch stop wherein the thermal acid generator is selected from the group consisting of a N-benzylanilinium salt and N-benzylpyridinium salt of nonafluorobutylsulfonate.

154. A thermally curable film coating composition for the manufacture of an integrated circuit comprising a blend of a latent, heat activatable catalyst that is a thermal acid generator with a polymerizable composition of claim 142 to provide a dielectric layer, photoresist layer, or hard mask etch stop wherein the thermal acid generator is selected from the group consisting of a N-benzylanilinium salt and N-benzylpyridinium salt of nonafluorobutylsulfonate.

155. A thermally curable film coating composition for the manufacture of an integrated circuit comprising a blend of a latent, heat activatable catalyst that is a thermal acid generator with a polymerizable composition of claim 143 to provide a dielectric layer, photoresist layer, or hard mask etch stop wherein the thermal acid generator is selected from the group consisting of a N-benzylanilinium salt and N-benzylpyridinium salt of nonafluorobutylsulfonate.

156. A thermally curable film coating composition for the manufacture of an integrated circuit comprising a blend of a latent, heat activatable catalyst that is a thermal acid generator with a polymerizable composition of claim 144 to provide a dielectric layer, photoresist layer, or hard mask etch stop wherein the thermal acid generator is selected from the group consisting of a N-benzylanilinium salt and N-benzylpyridinium salt of nonafluorobutylsulfonate.

157. A thermally curable film coating composition for the manufacture of an integrated circuit comprising a blend of a latent, heat activatable catalyst that is a thermal acid generator with a polymerizable composition of claim 93 or 94 to provide a dielectric layer, photoresist layer, or hard mask etch stop wherein the film forming composition is a co-condensing resin selected from the group consisting of (RO)₃Si(A)Si(OR)₃ wherein A is a polymer or oligomer —(SiB₂O)ₙ—, —(CB₂)ₙ—, or —(SiY₂)ₙ—, and R is methyl, ethyl, n-propyl or isopropyl and B is H, methyl, t-butyl, phenyl, 1,2-epoxyethyl, or 2,3-epoxypropyl.

158. A thermally curable film coating composition for the manufacture of an integrated circuit comprising a blend of a latent, heat activatable catalyst that is a thermal acid generator with a polymerizable composition of claim 157 to provide a dielectric layer, photoresist layer, or hard mask etch stop wherein the polymerizabel composition further comprises a hydroxyl group containing resin selected from the group consisting of hydroxyl containing polyesters, polyacrylates and polyoelfins.

159. A thermally curable film coating composition for the manufacture of an integrated circuit comprising a blend of a latent, heat activatable catalyst that is a thermal acid generator with a polymerizable composition of claim 157 to provide a dielectric layer, photoresist layer, or hard mask etch stop wherein the thermal acid generator is selected from the group consisting of a N-benzylanilinium salt and N-benzylpyridinium salt of fluorosubstituted C₁-C₁₂ alkyl sulfonate.

160. A thermally curable film coating composition for the manufacture of an integrated circuit comprising a blend of a latent, heat activatable catalyst that is a thermal acid generator with a polymerizable composition of claim 157 to provide a dielectric layer, photoresist layer, or hard mask etch stop wherein the thermal acid generator is selected from the group consisting of a N-benzylanilinium salt and N-benzylpyridinium salt of fluorosubstituted C₁-C₁₂ alkyl sulfonate.

161. A thermally curable film coating composition for the manufacture of an integrated circuit comprising a blend of a latent, heat activatable catalyst that is a thermal acid generator with a polymerizable composition of claim 157 to provide a dielectric layer, photoresist layer, or hard mask etch stop wherein the thermal acid generator is selected from the group consisting of a N-benzylanilinium salt and N-benzylpyridinium salt of trifluoromethane sulfonate.

162. A thermally curable film coating composition for the manufacture of an integrated circuit comprising a blend of a latent, heat activatable catalyst that is a thermal acid generator with a polymerizable composition of claim 158 to provide a dielectric layer, photoresist layer, or hard mask etch stop wherein the thermal acid generator is selected from the group consisting of a N-benzylanilinium salt and N-benzylpyridinium salt of trifluoromethane sulfonate.

163. A thermally curable film coating composition for the manufacture of an integrated circuit comprising a blend of a latent, heat activatable catalyst that is a thermal acid generator with a polymerizable composition of claim 157 to provide a dielectric layer, photoresist layer, or hard mask etch stop wherein the thermal acid generator is selected from the group consisting of a N-benzylanilinium salt and N-benzylpyridinium salt of nonafluorobutylsulfonate.

164. A thermally curable film coating composition for the manufacture of an integrated circuit comprising a blend of a latent, heat activatable catalyst that is a thermal acid generator with a polymerizable composition of claim 158 to provide a dielectric layer, photoresist layer, or hard mask etch stop wherein the thermal acid generator is selected from the group consisting of a N-benzylanilinium salt and N-benzylpyridinium salt of nonafluorobutylsulfonate.

165. A thermally curable film coating composition for the manufacture of an integrated circuit comprising a blend of a latent, heat activatable catalyst that is a thermal acid generator with a polymerizable composition of claim 93 or 94 to provide a dielectric layer, photoresist layer, or hard mask etch stop wherein the film forming composition is a crosslinkable composition is a hydroxy containing polyester resin derived from the polymerization of a diol, triol or tetraol with a diacid or triacid or an diester, triester or carboxylic acid anhydride or a mixture thereof.

166. A thermally curable film coating composition for the manufacture of an integrated circuit comprising a blend of a latent, heat activatable catalyst that is a thermal acid generator with a polymerizable composition of claim 165 to provide underlayers for multiple layer resists, or antireflective coatings, wherein the diol, triol or tetraol is selected from the group consisting of ethylene glycol, propylene glycol, pentanediol, hexanediol, glycerol 1,4-cyclohexanediethanol, hydroquinone, phenylenedimethanol, resorcinol, naphthalenediol, anthracene-1,10-diol, 1,3,5-tris(2-hydroxyehtyl cyanuric acid), trimethylol propane, pentarythiol, and a mixture thereof and the diacid or triacid, is selected from the group consisting of oxalic, malonic, succinic, adipic, phthalic, iso-phthalic, 5-nitroisophthalic, nitroterephthalic, naphthalene dicarboxylic, 1,2,3-benzenetricarboxylic, trimellitic acid and the diester or triester or carboxylic acid anhydride of the diacid or triacid.

167. A thermally curable film coating composition for the manufacture of an integrated circuit comprising a blend of a latent, heat activatable catalyst that is a thermal acid generator with a polymerizable composition of claim 165 to provide underlayers for multiple layer resists, or antireflective coatings, wherein the thermal acid generator is selected from the group consisting of a N-benzylanilinium salt and N-benzylpyridinium salt of fluorosubstituted C₁-C₁₂ alkyl sulfonate.

168. A thermally curable film coating composition for the manufacture of an integrated circuit comprising a blend of a latent, heat activatable catalyst that is a thermal acid generator with a polymerizable composition of claim 166 to provide underlayers for multiple layer resists, or antireflective coatings, wherein the thermal acid generator is selected from the group consisting of a N-benzylanilinium salt and N-benzylpyridinium salt of fluorosubstituted C₁-C₁₂ alkyl sulfonate.

169. A thermally curable film coating composition for the manufacture of an integrated circuit comprising a blend of a latent, heat activatable catalyst that is a thermal acid generator with a polymerizable composition of claim 165 to provide underlayers for multiple layer resists, or antireflective coatings, wherein the thermal acid generator is selected from the group consisting of a N-benzylanilinium salt and N-benzylpyridinium salt of trifluoromethane sulfonate.

170. A thermally curable film coating composition for the manufacture of an integrated circuit comprising a blend of a latent, heat activatable catalyst that is a thermal acid generator with a polymerizable composition of claim 166 to provide underlayers for multiple layer resists, or antireflective coatings, wherein the thermal acid generator is selected from the group consisting of a N-benzylanilinium salt and N-benzylpyridinium salt of trifluoromethane sulfonate.

171. A thermally curable film coating composition for the manufacture of an integrated circuit comprising a blend of a latent, heat activatable catalyst that is a thermal acid generator with a polymerizable composition of claim 165 to provide underlayers for multiple layer resists, or antireflective coatings, wherein the thermal acid generator is selected from the group consisting of a N-benzylanilinium salt and N-benzylpyridinium salt of nonafluorobutylsulfonate.

172. A thermally curable film coating composition for the manufacture of an integrated circuit comprising a blend of a latent, heat activatable catalyst that is a thermal acid generator with a polymerizable composition of claim 166 to provide underlayers for multiple layer resists, or antireflective coatings, wherein the thermal acid generator is selected from the group consisting of a N-benzylanilinium salt and N-benzylpyridinium salt of nonafluorobutylsulfonate.
